(19) United States
(12) Patent Application Publication
(10) Pub. No.: US 2024/0296593 A1
(43) Pub. Date: Sep. 5, 2024

(54) Conditional Image Compression

(71) Applicant: HUAWEI TECHNOLOGIES CO., LTD., Shenzhen (CN)

(72) Inventors: Alexander Alexandrovich Karabutov, Munich (DE); Panqi Jia, Munich (DE); Atanas Boev, Munich (DE); Han Gao, Shenzhen (CN); Biao Wang, Shenzhen (CN); Elena Alexandrovna Alshina, Munich (DE); Johannes Sauer, Munich (DE)

(21) Appl. No.: 18/661,245

(22) Filed: May 10, 2024

Related U.S. Application Data
(63) Continuation of application No. PCT/RU2021/000496, filed on Nov. 11, 2021.

(51) Int. Cl. G06T 9/00; H04N 19/13; H04N 19/167; H04N 19/186

(52) U.S. Cl. CPC G06T 9/002; H04N 19/13; H04N 19/167; H04N 19/186

(57) ABSTRACT

A conditional coding of components of an image is described. A method of encoding at least a portion of an image is provided, which comprises encoding a primary component of the image independently from at least one secondary component and encoding the at least one secondary component of the image using information from the primary component. Further, it is provided a method of encoding at least a portion of an image, comprising providing a residual comprising a primary residual component for a primary component of the image and at least one secondary residual component for at least one secondary component of the image that is different from the primary component, encoding the primary residual component independently from the at least one secondary residual component and encoding the at least one secondary residual component using information from the primary residual component.

### CROSS-REFERENCE TO RELATED APPLICATIONS

This application is a continuation of International Application No. PCT/RU2021/000496, filed on Nov. 11, 2021, the disclosure of which is hereby incorporated by reference in its entirety.

### TECHNICAL FIELD

Embodiments of the present disclosure relate to the field of image and video coding and, in particular, image and video coding comprising conditional image compression.

### BACKGROUND

Video coding (video encoding and decoding) is used in a wide range of digital video applications, for example broadcast digital TV, video transmission over internet and mobile networks, real-time conversational applications such as video chat, video conferencing, DVD and Blu-ray discs, video content acquisition and editing systems, and camcorders of security applications.

The amount of video data needed to depict even a relatively short video can be substantial, which may result in difficulties when the data is to be streamed or otherwise communicated across a communications network with limited bandwidth capacity. Thus, video data is generally compressed before being communicated across modern day telecommunications networks. The size of a video could also be an issue when the video is stored on a storage device because memory resources may be limited. Video compression devices often use software and/or hardware at the source to code the video data prior to transmission or storage, thereby decreasing the quantity of data needed to represent digital video images. The compressed data is then received at the destination by a video decompression device that decodes the video data. Compression techniques are also suitably applied in the context of still image coding.

With limited network resources and ever increasing demands of higher video quality, improved compression and decompression techniques that improve compression ratio with little to no sacrifice in image quality are desirable.

Neural networks (NNs) and deep-learning (DL) techniques, making use of artificial neural networks have now been used for some time, also in the technical field of encoding and decoding of videos, images (e.g. still images) and the like.

It is desirable to further improve efficiency of such image coding (video coding or still image coding) based on trained networks that account for limitations in available memory and/or processing speed.

In particular, conventional conditional image compression coding suffers from poor parallelization suitability and challenging memory demands.

### SUMMARY

Embodiments of the present disclosure relate to methods and apparatuses for coding image or video data, particularly, by means of neural networks, for example, neural networks that are described in the detailed description below. Usage of neural networks may allow for reliable encoding and decoding and estimation of entropy models in a self-learning manner resulting in a high accuracy of images reconstructed from encoded compressed input data.

According to a first aspect, it is provided a method of encoding at least a portion (for example, one or more blocks, slices, tiles, etc.) of an image, comprising (for at least the portion of the image) encoding a primary component of the image (selected from the components of the image) independently from at least one secondary (non-primary) component of the image (selected from the components of the image) and encoding the at least one secondary component of the image using information from the primary component.

Generally, the image may be a still image or an intra frame of a video sequence. Here and in the following description it is to be understood that the image comprises components, in particular, a brightness component and color components. A component may be considered a dimension of an orthogonal basis which describes a full color image. For example, when the image is represented in YUV space the components are the luma Y, the chroma U and the chroma V. One of the components of the image is selected as the primary component and one or more other ones of the components are selected as the secondary (non-primary) component(s). The terms “secondary component” and “non-primary component” are used interchangeably herein and denote a component that is coded using auxiliary information provided by the primary component. Encoding and decoding the secondary component(s) by using auxiliary information provided by the primary component results in a high accuracy of the reconstructed image obtained after decoding processing.

The provided kind of image encoding allows for a high parallelization (due to the encoding of the primary component independently from the secondary component) and reduced memory demands as compared to the art. Particularly, the primary component and the at least one secondary component can be encoded concurrently.

According to an implementation, the primary component of the image is a luma component and the at least one secondary component of the image is a chroma component. For example, two secondary components of the image are concurrently encoded one of which being a chroma component and the other one being another chroma component. According to another implementation, the primary component of the image is a chroma component and the at least one secondary component of the image is a luma component. Thus, a high flexibility of the actual conditioning of one component by another one is provided.

The overall encoding may comprise processing in the latent space which, particularly, may allow for processing of down-sampled input data and, thus, a fastened processing with a lower processing load. Note, that herein the terms “down-sampling” and “up-sampling” are used in the sense of reducing and enhancing the sizes of tensor representations of data, respectively.

With respect to processing in latent space according to an implementation
a) encoding the first component comprises;
representing the primary component by a first tensor;
transforming the first tensor into a first latent tensor; and
processing the first latent tensor to generate a first bitstream;
wherein
b) encoding the at least one secondary component comprises:
representing the at least one secondary component by a second tensor different from the first tensor;
concatenating the second tensor and the first tensor to obtain a concatenated tensor;
transforming the concatenated tensor into a second latent tensor; and
processing the second latent tensor to generate a second bitstream.

At least one of the size in the height dimension or the width dimension of the first latent tensor may be smaller than the corresponding size of the height dimension or the width dimension of the first tensor and/or the size in the height dimension or the width dimension of the second latent tensor may be smaller than the corresponding size of the height dimension or the width dimension of the concatenated tensor. Reduction rates by a factor of 16 or 32 in the height and/or width dimensions may be used, for example.

It might be the case that the size or a sub-pixel offset of samples of the second tensor in at least one of the height and width dimensions of the tensor differs from the size or sub-pixel offset of samples in at least one of the height and width dimensions of the first tensor. Therefore, according to another implementation
a) encoding the primary component comprises:
representing the primary component by a first tensor having a height dimension and a width dimension;
transforming the first tensor into a first latent tensor; and
processing the first latent tensor to generate a first bitstream;
wherein
b) encoding the at least one secondary component comprises:
representing the at least one secondary component by a second tensor different from the first tensor and having a height dimension and a width dimension;
determining whether the size or a sub-pixel offset of samples of the second tensor in at least one of the height and width dimensions differs from the size or sub-pixel offset of samples in at least one of the height and width dimensions of the first tensor, and when it is determined that the size or sub-pixel offset of samples of the second tensor differs from the size or sub-pixel offset of samples of the first tensor, adjusting the sample locations of the first tensor to match the sample locations of the second tensor thereby obtaining an adjusted first tensor;
concatenating the second tensor and the adjusted first tensor to obtain a concatenated tensor only when it is determined that the size or sub-pixel offset of samples of the second tensor differs from the size or sub-pixel offset of samples of the first tensor and else concatenating the second tensor and the first tensor to obtain a concatenated tensor;
transforming the concatenated tensor into a second latent tensor; and
processing the second latent tensor to generate a second bitstream.

Again, at least one of the size in the height dimension or the width dimension of the first latent tensor may be smaller than the corresponding size of the height dimension or the width dimension of the first tensor and/or the size in the height dimension or the width dimension of the second latent tensor may be smaller than the corresponding size of the height dimension or the width dimension of the concatenated tensor. Reduction rates by a factor of 16 or 32 in the height and/or width dimensions may be used, for example. Adjusting the sample locations of the first tensor to match the sample locations of the second tensor may comprise a down-sampling in width and height of the first tensor by a factor of 2, for example.

According to an implementation, the first latent tensor comprises a channel dimension and the second latent tensor comprises a channel dimension and the size of the first latent tensor in the channel dimension is one of larger than, smaller than and equal to the size of the second latent tensor in the channel dimension. If the primary component is considered of larger importance as compared to the secondary component(s), which usually may be the case, the channel length of the primary component may be larger than the one of the secondary component(s). If the signal of the primary component is relatively clear and the signals of the non-primary component(s) is (are) relatively noisy, the channel length of the primary component may be smaller than the one of the secondary component(s). Numerical experiments have shown that shorter channel lengths as compared to the art can be used without significant degradation of the quality of the reconstructed image and, therefore, memory demands can be reduced.

In general, the first tensor may be transformed into the first latent tensor by means of a first neural network and the concatenated tensor may be transformed into the second latent tensor by means of a second neural network different from the first neural network. In this case, the first and second neural networks may be cooperatively trained in order to determine the size of the first latent tensor in the channel dimension and the size of the second latent tensor in the channel dimension. Determination of the channel lengths may be performed by exhaustive search or in a content-adaptive manner. A set of models may be trained wherein each model is based on a different number of channels for encoding of the primary and non-primary components. Thereby, the neural networks may be able to optimize the channel lengths involved.

The determined channel lengths have to be also used by decoders used for reconstructing the encoded components. Therefore, according to an implementation, the size of the first latent tensor in the channel dimension may be signaled in the first bitstream and the size of the second latent tensor in the channel dimension may be signaled in the second bitstream. The signaling may be performed explicitly or implicitly and allows for informing the decoders about the channel lengths directly in a bit saving manner.

According to an implementation, the first bitstream is generated based on a first entropy model and the second bitstream is generated based on a second entropy model different from the first entropy model. Such entropy models allow for reliably estimating statistical properties used in the process of converting tensor representations of data into bitstreams.

The disclosed method may advantageously be implemented in the context of a hyper-prior architecture that provides side information useful for the coding of the (portion of the) image in order improve the accuracy of the reconstructed (portion of the) image. According to a particular implementation, the method further comprising
A)
transforming the first latent tensor into a first hyper-latent tensor;
processing the first hyper-latent tensor to generate a third bitstream based on a third entropy model;
decoding the third bitstream using the third entropy model to obtain a recovered first hyper-latent tensor;
transforming the recovered first hyper-latent tensor into a first hyper-decoded hyper-latent tensor; and
generating the first entropy model based on the first hyper-decoded hyper-latent tensor and the first latent tensor; and
B)
transforming the second latent tensor into a second hyper-latent tensor different from the first hyper-latent tensor;
processing the second hyper-latent tensor to generate a fourth bitstream based on a fourth entropy model;
decoding the fourth bitstream using the fourth entropy model to obtain a recovered second hyper-latent tensor;
transforming the recovered second hyper-latent tensor into a second hyper-decoded hyper-latent tensor; and
generating the second entropy model based on the second hyper-decoded hyper-latent tensor and the second latent tensor.

Transforming the first latent tensor into the first hyper-latent tensor may comprise down-sampling of the first latent tensor and transforming the second latent tensor into the second hyper-latent tensor may comprise down-sampling of the second latent tensor, for example, by a factor 2 or 4, in order to further reduce the processing load.

The generated first and second entropy models that are used for encoding the latent representations of the primary component and the concatenated tensor, respectively, may be autoregressive entropy models.

Neural networks may also be used for the generation of the entropy models. For example, the third entropy model is generated by a third neural network different from the first and second neural networks and the fourth entropy model is generated by a fourth neural network different from the first, second and third neural networks. Furthermore, the third bitstream may be generated by a fifth neural network different from the first to fourth neural networks and decoded by a sixth neural network different from the first to fifth neural networks and the fourth bitstream may be generated by a seventh neural network different from the first to sixth neural networks and decoded by an eighth neural network different from the first to seventh neural networks. Further, the first entropy model may be generated by a ninth neural network different from the first to eighth neural networks used for encoding the latent representation of the primary component and the second entropy model used for encoding the latent representations of the concatenated tensor may be generated by a tenth neural network different from the first to ninth networks.

According to a second aspect, it is provided a method of encoding at least a portion of an image, comprising (for at least the portion of the image) providing a residual comprising a primary residual component for a primary component of the image and at least one secondary residual component for at least one secondary component of the image that is different from the primary component, encoding the primary residual component independently from the at least one secondary residual component and encoding the at least one secondary residual component using information from the primary residual component. The thus processed image can be an inter frame of a video sequence or a still image. The residual results from a subtraction of a current portion of (a portion of) an image from a predicted one and has residual components one for each of the components of the image, respectively. Conditional residual encoding according to this method can be performed with the same advantages as the method according to the first aspect described above. Compared to conditional residual coding known in the art (see detailed description below) memory demands can be reduced since smaller channel lengths can be used for data representations in latent space without significantly losing accuracy in image reconstruction.

The primary residual component and the at least one secondary residual component may be encoded concurrently. The primary component of the image may be a luma component and the at least one secondary component of the image may be a chroma component. In this case, the at least one secondary residual component may comprise a residual component for a chroma component and another residual component for another chroma component. Alternatively, the primary component of the image may be a chroma component and the at least one secondary component of the image may be a luma component.

Again, processing can be performed in latent space. According to an implementation of the method according to the second aspect,
a) encoding the primary residual component comprises:
representing the primary residual component by a first tensor;
transforming the first tensor into a first latent tensor (for example, of smaller size in width and/or height dimensions as compared to the first tensor); and
processing the first latent tensor to generate a first bitstream;
and wherein
b) encoding the at least one secondary residual component comprises:
representing the at least one secondary residual component by a second tensor different from the first tensor;
concatenating the second tensor and the first tensor to obtain a concatenated tensor;
transforming the concatenated tensor into a second latent tensor (for example, of smaller size in width and/or height dimensions as compared to the concatenated tensor); and
processing the second latent tensor to generate a second bitstream.

According to another implementation of the method according to the second aspect
a) encoding the primary residual component comprises:
representing the primary residual component by a first tensor having a height dimension and a width dimension;
transforming the first tensor into a first latent tensor; and processing the first latent tensor to generate a first bitstream;
and wherein
b) encoding the at least one secondary residual component comprises:
representing the at least one secondary residual component by a second tensor different from the first tensor and having a height dimension and a width dimension;
determining whether the size or a sub-pixel offset of samples of the second tensor in at least one of the height and width dimensions differs from the size or sub-pixel offset of samples in at least one of the height and width dimensions of the first tensor, and when it is determined that the size or sub-pixel offset of samples of the second tensor differs from the size or sub-pixel offset of samples of the first tensor, adjusting the sample locations of the first tensor to match the sample locations of the second tensor thereby obtaining an adjusted first tensor;
concatenating the second tensor and the adjusted first tensor to obtain a concatenated tensor only when it is determined that the size or sub-pixel offset of samples of the second tensor differs from the size or sub-pixel offset of samples of the first tensor, and else concatenating the second tensor and the first tensor to obtain a concatenated tensor; transforming the concatenated tensor into a second latent tensor; and
processing the second latent tensor to generate a second bitstream.

Again, at least one of the size in the height dimension or the width dimension of the first latent tensor may aspect. Thus, the method according to the second aspect may further comprise
A)
transforming the first latent tensor into a first hyper-latent tensor;
processing the first hyper-latent tensor to generate a third bitstream based on a third entropy model;
decoding the third bitstream using the third entropy model to obtain a recovered first hyper-latent tensor;
transforming the recovered first hyper-latent tensor into a first hyper-decoded hyper-latent tensor; and
generating the first entropy model based on the first hyper-decoded hyper-latent tensor and the first latent tensor; and
B)
transforming the second latent tensor into a second hyper-latent tensor different from the first hyper-latent tensor;
processing the second hyper-latent tensor to generate a fourth bitstream based on a fourth entropy model;
decoding the fourth bitstream using the fourth entropy model to obtain a recovered second hyper-latent tensor;
transforming the recovered second hyper-latent tensor into a second hyper-decoded hyper-latent tensor; and
generating the second entropy model based on the second hyper-decoded hyper-latent tensor and the second latent tensor.

Transforming the first latent tensor into the first hyper-latent tensor may comprise down-sampling of the first latent tensor and transforming the second latent tensor into the second hyper-latent tensor may comprise down-sampling of the second latent tensor, for example, by a factor 2 or 4.

The third entropy model may be generated by a third neural network different from the first and second neural networks and the fourth entropy model may be generated by a fourth neural network different from the first, second and third neural networks. Further, the third bitstream may be generated by a fifth neural network different from the first to fourth neural networks and decoded by a sixth neural network different from the first to fifth neural networks and the fourth bitstream may be generated by a seventh neural network different from the first to sixth neural networks and decoded by an eighth neural network different from the first to seventh neural networks. Further, the first entropy model may be generated by a ninth neural network different from the first to eighth neural networks and the second entropy model may be generated by a tenth neural network different from the first to ninth networks.

It is noted that in the above-described aspects and implementations tensors that are converted into bitstreams may be subject to quantization before that conversion process. Quantization compresses a range of values to a single value in order to reduce the amount of data to be processed.

Corresponding to the above-described encoding methods, herein, methods of reconstructing at least a portion of an image based on conditional coding are also provided with the same or similar advantages as described above. Reconstruction of at least the portion of the image can be facilitated by the employment of neural networks, for example, neural networks that are described in the detailed description below.

According to a third aspect, it is provided a method of reconstructing at least a portion of an image, comprising (for at least the portion of the image) processing a first bitstream based on a first entropy model to obtain a first latent tensor and processing the first latent tensor to obtain a first tensor representing a primary component of the image. Furthermore, the method comprises (for at least the portion of the image) processing a second bitstream different from the first bitstream based on a second entropy model different from the first entropy model to obtain a second latent tensor different from the first latent tensor and processing the second latent tensor to obtain a second tensor representing at least one secondary component of the image using information from the first latent tensor. In principle, the image can be a still image or an intra frame of a video sequence.

The first and second entropy models may be provided by the hyper-prior pipelines described above.

The first latent tensor can be processed independently from the processing of the second latent tensor. In fact, an encoded primary component can be recovered even if data for the secondary component gets lost. The compressed original image data can be reliably and, due to the possible parallel processing of the first and second bitstreams, speedily by reconstructed by this method.

The primary component of the image may be a luma component and the at least one secondary component of the image may be a chroma component. In particular, the second tensor may represent two secondary components one of which being a chroma component and the other one being another chroma component. Alternatively, the primary component of the image may be a chroma component and the at least one secondary component of the image may be a luma component.

According to an implementation of the method according to the third aspect, the processing of the first latent tensor comprises transforming the first latent tensor into the first tensor and the processing of the second latent tensor comprises concatenating the second latent tensor and the first latent tensor to obtain a concatenated tensor and transforming the concatenated tensor into the second tensor. At least one of these transformations may include up-sampling. Thus, processing in latent space may be performed at a lower resolution as it is necessary for the accurate reconstruction of the components in YUV space or any other space that is suitably used for the image representation.

According to another implementation of the method according to the third aspect, each of the first and second latent tensors has a height and a width dimension and the processing of the first latent tensor comprises transforming the first latent tensor into the first tensor and the processing of the second latent tensor comprises determining whether the size or a sub-pixel offset of samples of the second latent tensor in at least one of the height and width dimensions differs from the size or sub-pixel offset of samples in at least one of the height and width dimensions of the first latent tensor. When it is determined that the size or sub-pixel offset of samples of the second latent tensor differs from the size or sub-pixel offset of samples of the first latent tensor, the sample locations of the first latent tensor are adjusted to match the sample locations of the second latent tensor. Thereby an adjusted first latent tensor is obtained. Further, the second latent tensor and the adjusted first latent tensor are concatenated to obtain a concatenated latent tensor only when it is determined that the size or sub-pixel offset of samples of the second latent tensor differs from the size or sub-pixel offset of samples of the first latent tensor and else concatenating the second latent tensor and the first latent tensor is performed to obtain a concatenated latent tensor and the concatenated latent tensor is transformed into the second tensor.

The first bitstream may be processed by a first neural network and the second bitstream may be processed by a second neural network different from the first neural network. The first latent tensor may be transformed by a third neural network different from the first and second networks and the concatenated latent tensor may be transformed by a fourth neural network different from the first, second and third networks.

According to another implementation of the method according to the third aspect, the first latent tensor comprises a channel dimension and the second latent tensor comprises a channel dimension and the size of the first latent tensor in the channel dimension is one of larger than, smaller than and equal to the size of the second latent tensor in the channel dimension. Information on the size of the first and second latent tensors in the channel dimension may be obtained from information signaled in the first and second bitstreams, respectively.

According to a fourth aspect, it is provided a method of reconstructing at least a portion of an image comprising (for at least the portion of the image) processing a first bitstream based on a first entropy model to obtain a first latent tensor and processing the first latent tensor to obtain a first tensor representing a primary residual component of a residual for a primary component of the image. Further, this method comprises (for at least the portion of the image) processing a second bitstream different from the first bitstream based on a second entropy model different from the first entropy model to obtain a second latent tensor different from the first latent tensor and processing the second latent tensor to obtain a second tensor representing at least one secondary residual component of the residual for at least one secondary component of the image using information from the first latent tensor. Thus, a residual is obtained that comprises a first residual component for a primary component and a second residual component for at least one secondary component. In principle, the image can be a still image or an inter frame of a video sequence.

The first and second entropy models may be provided by the hyper-prior pipelines described above.

The first latent tensor may be processed independently from the processing of the second latent tensor.

The primary component of the image may be a luma component and the at least one secondary component of the image may be a chroma component. In this case, the second tensor may represent two residual components for two secondary components one of which being a chroma component and the other one being another chroma component. Alternatively, the primary component of the image may be a chroma component and the at least one secondary component of the image may be a luma component.

According to an implementation of the method according to the fourth aspect, the processing of the first latent tensor comprises transforming the first latent tensor into the first tensor and the processing of the second latent tensor comprises concatenating the second latent tensor and the first latent tensor to obtain a concatenated tensor and transforming the concatenated tensor into the second tensor.

At least one of these transformations may include up-sampling. Thus, processing in latent space may be performed at a lower resolution as it is necessary for the accurate reconstruction of the components in YUV space or any other space that is suitably used for the image representation.

According to another implementation of the method according to the fourth aspect, each of the first and second latent tensors has a height and a width dimension and the processing of the first latent tensor comprises transforming the first latent tensor into the first tensor and the processing of the second latent tensor comprises determining whether the size or a sub-pixel offset of samples of the second latent tensor in at least one of the height and width dimensions differs from the size or sub-pixel offset of samples in at least one of the height and width dimensions of the first latent tensor. When it is determined that the size or sub-pixel offset of samples of the second latent tensor differs from the size or sub-pixel offset of samples of the first latent tensor, the sample locations of the first latent tensor are adjusted to match the sample locations of the second latent tensor. Thereby an adjusted first latent tensor is obtained. Furthermore, the second latent tensor and the adjusted first latent tensor are concatenated to obtain a concatenated latent tensor only when it is determined that the size or sub-pixel offset of samples of the second latent tensor differs from the size or sub-pixel offset of samples of the first latent tensor and else concatenating the second latent tensor and the first latent tensor is performed to obtain a concatenated latent tensor. Further, the concatenated latent tensor is transformed into the second tensor.

The first bitstream may be processed by a first neural network and the second bitstream may be processed by a second neural network different from the first neural network. The first latent tensor may be transformed by a third neural network different from the first and second networks and the concatenated latent tensor may be transformed by a fourth neural network different from the first, second and third networks.

According to another implementation of the method according to the fourth aspect, the first latent tensor comprises a channel dimension and the second latent tensor comprises a channel dimension and wherein the size of the first latent tensor in the channel dimension is one of larger than, smaller than and equal to the size of the second latent tensor in the channel dimension.

The processing of the first bitstream may comprise obtaining information on the size of the first latent tensor in the channel dimension signaled in the first bitstream and the processing of the second bitstream may comprise obtaining information on the size of the second latent tensor in the channel dimension signaled in the second bitstream.

Any of the above-described exemplary implementations may be combined as considered appropriate. The method according to any of the above described aspects and implementations can be implemented in an apparatus.

According to a fifth aspect, it is provided an apparatus for encoding at least a portion of an image, the apparatus comprising one or more processors and a non-transitory computer-readable storage medium coupled to the one or more processors and storing programming for execution by the one or more processors, wherein the programming, when executed by the one or more processors, configures the apparatus to carry out the method according to any one of the first and second aspects and the corresponding implementations described above.

According to a sixth aspect, it is provided an apparatus for reconstructing at least a portion of an image, the apparatus comprising one or more processors and a non-transitory computer-readable storage medium coupled to the one or more processors and storing programming for execution by the one or more processors, wherein the programming, when executed by the one or more processors, configures the apparatus to carry out the method according to any one of the third and fourth aspects and the corresponding implementations described above.

According to a seventh aspect, it is provided a processing apparatus for encoding at least a portion of an image, the processing apparatus comprising a processing circuitry configured for encoding (for at least the portion of the image) a primary component of the image independently from at least one secondary component of the image and encoding (for at least the portion of the image) the at least one secondary component of the image using information from the primary component.

This processing apparatus is configured to perform the steps of the method according to the first aspect and it can also be configured to perform the steps of one or more of the corresponding implementations described above.

According to an eight aspect, it is provided processing apparatus for encoding at least a portion of an image, the processing apparatus comprising a processing circuitry configured for: providing a residual comprising a primary residual component for a primary component of the image and at least one secondary residual component for at least one secondary component of the image that is different from the primary component, encoding the primary residual component independently from the at least one secondary residual component, and encoding the at least one secondary residual component using information from the primary residual component.

This processing apparatus is configured to perform the steps of the method according to the second aspect and it can also be configured to perform the steps of one or more of the corresponding implementations described above.

According to a ninth aspect, it is provided a processing apparatus for reconstructing at least a portion of an image, the processing apparatus comprising a processing circuitry configured for: processing a first bitstream based on a first entropy model to obtain a first latent tensor, processing the first latent tensor to obtain a first tensor representing the primary component of the image, processing a second bitstream different from the first bitstream based on a second entropy model different from the first entropy model to obtain a second latent tensor different from the first latent tensor, and processing the second latent tensor to obtain a second tensor representing the at least one secondary component of the image using information from the first latent tensor.

This processing apparatus is configured to perform the steps of the method according to the third aspect and it can also be configured to perform the steps of one or more of the corresponding implementations described above.

According to a tenth aspect, it is provided a processing apparatus for reconstructing at least a portion of an image, the processing apparatus comprising a processing circuitry configured for: processing a first bitstream based on a first entropy model to obtain a first latent tensor, processing the first latent tensor to obtain a first tensor representing a primary residual component of a residual for a primary component of the image, processing a second bitstream different from the first bitstream based on a second entropy model different from the first entropy model to obtain a second latent tensor different from the first latent tensor, and processing the second latent tensor to obtain a second tensor representing at least one secondary residual component of the residual for at least one secondary component of the image using information from the first latent tensor.

This processing apparatus is configured to perform the steps of the method according to the fourth aspect and it can also be configured to perform the steps of one or more of the corresponding implementations described above.

Furthermore, according to an eleventh aspect, it is provided a computer program stored on a non-transitory medium comprising a code which when executed on one or more processors performs the steps of the method according to any of the above described aspects and implementations.

### BRIEF DESCRIPTION OF THE DRAWINGS

In the following technical background and embodiments of the invention are described in more detail with reference to the attached figures and drawings, in which

FIG. 1 is a schematic drawing illustrating channels processed by layers of a neural network;

FIG. 2 is a schematic drawing illustrating an autoencoder type of a neural network;

FIG. 3 is a schematic drawing illustrating network architecture including a hyperprior model;

FIG. 4 is a block diagram illustrating a structure of a cloud-based solution for machine based tasks such as machine vision tasks;

FIG. 5 is a block diagram illustrating a structure of end-to-end trainable video compression framework;

FIG. 6 is a block diagram illustrating a network for motion vectors (MV) compression;

FIG. 7 is a block diagram that illustrates a learned image compression configuration of the art;

FIG. 8 is a block diagram that illustrates another learned image compression configuration of the art;

FIG. 9 illustrates the concept of conditional coding;

FIG. 10 illustrates the concept of residual coding;

FIG. 11 illustrates the concept of residual conditional coding;

FIG. 12 illustrates conditional intra coding in accordance with an embodiment of the present disclosure;

FIG. 13 illustrates conditional residual coding in accordance with an embodiment of the present disclosure;

FIG. 14 illustrates conditional coding in accordance with an embodiment of the present disclosure;

FIG. 15 illustrates conditional intra coding for input data in the YUV420 format in accordance with an embodiment of the present disclosure;

FIG. 16 illustrates conditional intra coding for input data in the YUV444 format in accordance with an embodiment of the present disclosure;

FIG. 17 illustrates conditional residual coding for input data in the YUV420 format in accordance with an embodiment of the present disclosure;

FIG. 18 illustrates conditional residual coding for input data in the YUV444 format in accordance with an embodiment of the present disclosure;

FIG. 19 illustrates conditional residual coding for input data in the YUV420 format in accordance with another embodiment of the present disclosure;

FIG. 20 illustrates conditional residual coding for input data in the YUV444 format in accordance with another embodiment of the present disclosure;

FIG. 21 is a flow chart illustrating an exemplary method of encoding at least a portion of an image in accordance with an embodiment of the present disclosure;

FIG. 22 is a flow chart illustrating an exemplary method of encoding at least a portion of an image in accordance with another embodiment of the present disclosure;

FIG. 23 is a flow chart illustrating an exemplary method of reconstructing at least a portion of an image in accordance with an embodiment of the present disclosure;

FIG. 24 is a flow chart illustrating an exemplary method of reconstructing at least a portion of an image in accordance with another embodiment of the present disclosure;

FIG. 25 illustrate a processing apparatus configured for carrying out a method of encoding or reconstructing at least a portion of an image in accordance with an embodiment of the present disclosure;

FIG. 26 is a block diagram showing an example of a video coding system configured to implement embodiments of the present disclosure;

FIG. 27 is a block diagram showing another example of a video coding system configured to implement embodiments of the present disclosure;

FIG. 28 is a block diagram illustrating an example of an encoding apparatus or a decoding apparatus in accordance with an embodiment of the present disclosure; and

FIG. 29 is a block diagram illustrating another example of an encoding apparatus or a decoding apparatus in accordance with an embodiment of the present disclosure.

### DESCRIPTION

In the following description, reference is made to the accompanying figures, which form part of the disclosure, and which show, by way of illustration, specific aspects of embodiments of the invention or specific aspects in which embodiments of the present invention may be used. It is understood that embodiments of the invention may be used in other aspects and comprise structural or logical changes not depicted in the figures. The following detailed description, therefore, is not to be taken in a limiting sense, and the scope of the present invention is defined by the appended claims.

For instance, it is understood that a disclosure in connection with a described method may also applied to a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

In the following, an overview over some of the used technical terms is provided.

### Artificial Neural Networks

Artificial neural networks (ANN) or connectionist systems are computing systems vaguely inspired by the biological neural networks that constitute animal brains. Such systems “learn” to perform tasks by considering examples, generally without being programmed with task-specific rules. For example, in image recognition, they might learn to identify images that contain cats by analyzing example images that have been manually labeled as “cat” or “no cat” and using the results to identify cats in other images. They do this without any prior knowledge of cats, for example, that they have fur, tails, whiskers and cat-like faces. Instead, they automatically generate identifying characteristics from the examples that they process.

An ANN is based on a collection of connected units or nodes called artificial neurons, which loosely model the neurons in a biological brain. Each connection, like the synapses in a biological brain, can transmit a signal to other neurons. An artificial neuron that receives a signal then processes it and can signal neurons connected to it.

In ANN implementations, the “signal” at a connection is a real number, and the output of each neuron is computed by some non-linear function of the sum of its inputs. The connections are called edges. Neurons and edges typically have a weight that adjusts as learning proceeds. The weight increases or decreases the strength of the signal at a connection. Neurons may have a threshold such that a signal is sent only if the aggregate signal crosses that threshold. Typically, neurons are aggregated into layers. Different layers may perform different transformations on their inputs. Signals travel from the first layer (the input layer), to the last layer (the output layer), possibly after traversing the layers multiple times.

The original goal of the ANN approach was to solve problems in the same way that a human brain would. Over time, attention moved to performing specific tasks, leading to deviations from biology. ANNs have been used on a variety of tasks, including computer vision, speech recognition, machine translation, social network filtering, playing board and video games, medical diagnosis, and even in activities that have traditionally been considered as reserved to humans, like painting.

### Convolutional Neural Networks

The name “convolutional neural network” (CNN) indicates that the network employs a mathematical operation called convolution. Convolution is a specialized kind of linear operation. Convolutional networks are simply neural networks that use convolution in place of general matrix multiplication in at least one of their layers.

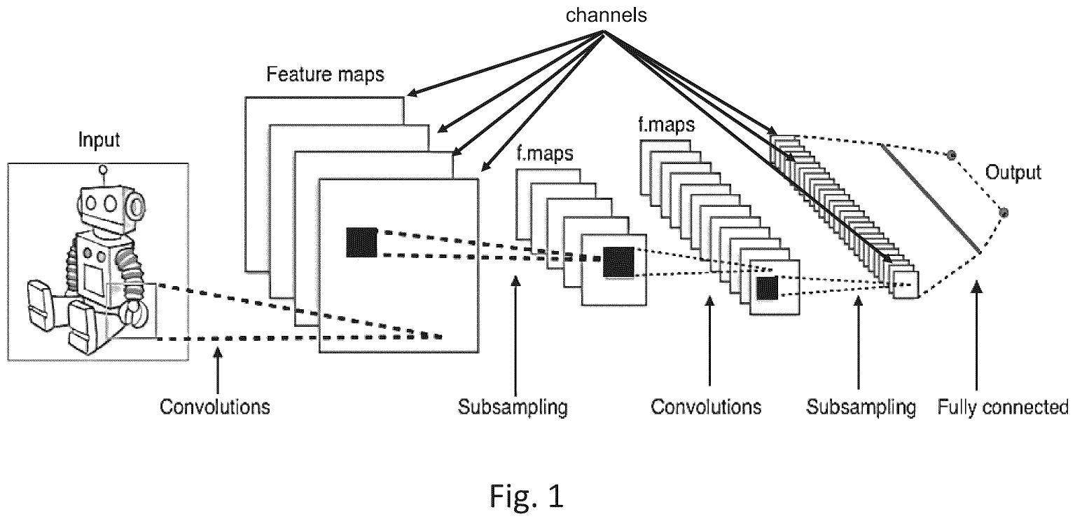

FIG. 1 schematically illustrates a general concept of processing by a neural network such as the CNN. A convolutional neural network consists of an input and an output layer, as well as multiple hidden layers. Input layer is the layer to which the input (such as a portion of an image as shown in FIG. 1) is provided for processing. The hidden layers of a CNN typically consist of a series of convolutional layers that convolve with a multiplication or other dot product. The result of a layer is one or more feature maps (f.maps in FIG. 1), sometimes also referred to as channels. There may be a subsampling involved in some or all of the layers. As a consequence, the feature maps may become smaller, as illustrated in FIG. 1. The activation function in a CNN is usually a RELU (Rectified Linear Unit) layer, and is subsequently followed by additional convolutions such as pooling layers, fully connected layers and normalization layers, referred to as hidden layers because their inputs and outputs are masked by the activation function and final convolution. Though the layers are colloquially referred to as convolutions, this is only by convention. Mathematically, it is technically a sliding dot product or cross-correlation. This has significance for the indices in the matrix, in that it affects how weight is determined at a specific index point.

When programming a CNN for processing images, as shown in FIG. 1, the input is a tensor with shape (number of images)×(image width)×(image height)×(image depth).

Then after passing through a convolutional layer, the image becomes abstracted to a feature map, with shape (number of images)×(feature map width)×(feature map height)×(feature map channels). A convolutional layer within a neural network should have the following attributes. Convolutional kernels defined by a width and height (hyper-parameters). The number of input channels and output channels (hyper-parameter). The depth of the convolution filter (the input channels) should be equal to the number channels (depth) of the input feature map.

In the past, traditional multilayer perceptron (MLP) models have been used for image recognition. However, due to the full connectivity between nodes, they suffered from high dimensionality, and did not scale well with higher resolution images. A 1000×1000-pixel image with RGB color channels has 3 million weights, which is too high to feasibly process efficiently at scale with full connectivity. Also, such network architecture does not take into account the spatial structure of data, treating input pixels which are far apart in the same way as pixels that are close together. This ignores locality of reference in image data, both computationally and semantically. Thus, full connectivity of neurons is wasteful for purposes such as image recognition that are dominated by spatially local input patterns.

Convolutional neural networks are biologically inspired variants of multilayer perceptrons that are specifically designed to emulate the behavior of a visual cortex. These models mitigate the challenges posed by the MLP architecture by exploiting the strong spatially local correlation present in natural images. The convolutional layer is the core building block of a CNN. The layer's parameters consist of a set of learnable filters (the above-mentioned kernels), which have a small receptive field, but extend through the full depth of the input volume. During the forward pass, each filter is convolved across the width and height of the input volume, computing the dot product between the entries of the filter and the input and producing a 2-dimensional activation map of that filter. As a result, the network learns filters that activate when it detects some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map. A feature map, or activation map, is the output activations for a given filter. Feature map and activation has same meaning. In some papers it is called an activation map because it is a mapping that corresponds to the activation of different parts of the image, and also a feature map because it is also a mapping of where a certain kind of feature is found in the image. A high activation means that a certain feature was found.

Another important concept of CNNs is pooling, which is a form of non-linear down-sampling. There are several non-linear functions to implement pooling among which max pooling is the most common. It partitions the input image into a set of non-overlapping rectangles and, for each such sub-region, outputs the maximum.

Intuitively, the exact location of a feature is less important than its rough location relative to other features. This is the idea behind the use of pooling in convolutional neural networks. The pooling layer serves to progressively reduce the spatial size of the representation, to reduce the number of parameters, memory footprint and amount of computation in the network, and hence to also control overfitting. It is common to periodically insert a pooling layer between successive convolutional layers in a CNN architecture. The pooling operation provides another form of translation invariance.

The pooling layer operates independently on every depth slice of the input and resizes it spatially. The most common form is a pooling layer with filters of size 2×2 applied with a stride of 2 down-samples at every depth slice in the input by 2 along both width and height, discarding 75% of the activations. In this case, every max operation is over 4 numbers. The depth dimension remains unchanged.

In addition to max pooling, pooling units can use other functions, such as average pooling or (2-norm pooling. Average pooling was often used historically but has recently fallen out of favour compared to max pooling, which performs better in practice. Due to the aggressive reduction in the size of the representation, there is a recent trend towards using smaller filters or discarding pooling layers altogether. “Region of Interest” pooling (also known as ROI pooling) is a variant of max pooling, in which output size is fixed and input rectangle is a parameter. Pooling is an important component of convolutional neural networks for object detection based on Fast R-CNN architecture.

The above-mentioned ReLU is the abbreviation of rectified linear unit, which applies the non-saturating activation function. It effectively removes negative values from an activation map by setting them to zero. It increases the nonlinear properties of the decision function and of the overall network without affecting the receptive fields of the convolution layer. Other functions are also used to increase nonlinearity, for example the saturating hyperbolic tangent and the sigmoid function. ReLU is often preferred to other functions because it trains the neural network several times faster without a significant penalty to generalization accuracy.

After several convolutional and max pooling layers, the high-level reasoning in the neural network is done via fully connected layers. Neurons in a fully connected layer have connections to all activations in the previous layer, as seen in regular (non-convolutional) artificial neural networks. Their activations can thus be computed as an affine transformation, with matrix multiplication followed by a bias offset (vector addition of a learned or fixed bias term).

The “loss layer” specifies how training penalizes the deviation between the predicted (output) and true labels and is normally the final layer of a neural network. Various loss functions appropriate for different tasks may be used. Softmax loss is used for predicting a single class of K mutually exclusive classes. Sigmoid cross-entropy loss is used for predicting K independent probability values in [0, 1]. Euclidean loss is used for regressing to real-valued labels.

In summary, FIG. 1 shows the data flow in typical convolutional neural network. First, the input image is passed through convolutional layer and becomes abstracted to a feature map comprising several channels, corresponding to number of filters in a set of learnable filters of this layer. Then feature map is subsampled using e.g. pooling layer, which reduces dimension of each channel in feature map. Next data comes to another convolutional layer, which may have different numbers of output channels leading to different number of channels in feature map. As was mentioned above, the number of input channels and output channels are hyper-parameters of the layer. To establish connectivity of the network those parameters needs to be synchronized between two connected layers, such as number of input channels for the current layers should be equal to number of output channels of previous layer. For the first layer which process input data, e.g. image, the number of input channels is normally equal to number of channels of data representation, for instance 3 channels for RGB or YUV representation of images or video, or 1 channel for grayscale image or video representation.

### Autoencoders and Unsupervised Learning

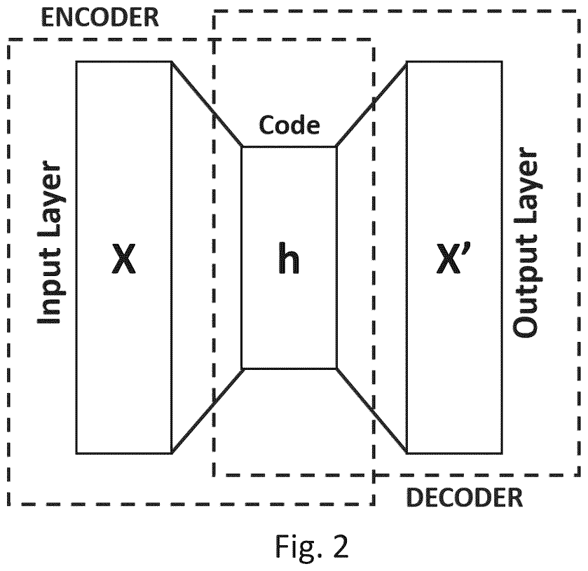

An autoencoder is a type of artificial neural network used to learn efficient data codings in an unsupervised manner. A schematic drawing thereof is shown in FIG. 2. The aim of an autoencoder is to learn a representation (encoding) for a set of data, typically for dimensionality reduction, by training the network to ignore signal “noise”. Along with the reduction side, a reconstructing side is learnt, where the autoencoder tries to generate from the reduced encoding a representation as close as possible to its original input, hence its name. In the simplest case, given one hidden layer, the encoder stage of an autoencoder takes the input x and maps it to h

$$h = σ ( W x + b ) .$$

This image h is usually referred to as code, latent variables, or latent representation. Here, σ is an element-wise activation function such as a sigmoid function or a rectified linear unit. W is a weight matrix b is a bias vector. Weights and biases are usually initialized randomly, and then updated iteratively during training through Backpropagation. After that, the decoder stage of the autoencoder maps h to the reconstruction x′ of the same shape as x:

$${x}^{′} = {σ}^{′} ( {W}^{′} {h}^{′} + {b}^{′} )$$

where σ′, W′ and b′ for the decoder may be unrelated to the corresponding σ, W and b for the encoder.

Variational autoencoder models make strong assumptions concerning the distribution of latent variables. They use a variational approach for latent representation learning, which results in an additional loss component and a specific estimator for the training algorithm called the Stochastic Gradient Variational Bayes (SGVB) estimator. It assumes that the data are generated by a directed graphical model p_{θ}(x|h) and that the encoder is learning an approximation q_{ϕ}(h|x) to the posterior distribution p_{θ}(h|x) where ϕ and θ denote the parameters of the encoder (recognition model) and decoder (generative model) respectively. The probability distribution of the latent vector of a VAE typically matches that of the training data much closer than a standard autoencoder. The objective of VAE has the following form:

$$ℒ ( ϕ , θ , x ) = {D}_{K L} ( {q}_{ϕ} ( h \vert x ) \vert \vert {p}_{θ} ( h ) ) - {E}_{{q}_{ϕ} ( h \vert x )} ( log {p}_{θ} ( x \vert h ) )$$

Here, D_{KL} stands for the Kullback-Leibler divergence. The prior over the latent variables is usually set to be the centered isotropic multivariate Gaussian p_{θ}(h)= [symbol] (0, I). Commonly, the shape of the variational and the likelihood distributions are chosen such that they are factorized Gaussians:

$${q}_{ϕ} ( h \vert x ) = 𝒩 ( ρ ( x ) , {ω}^{2} ( x ) I )$$

$${p}_{ϕ} ( x \vert h ) = 𝒩 ( μ ( h ) , {σ}^{2} ( h ) I )$$

where ρ(x) and ω² (x) are the encoder output, while μ(h) and σ² (h) are the decoder outputs.

Recent progress in artificial neural networks area and especially in convolutional neural networks enables researchers' interest of applying neural networks based technologies to the task of image and video compression. For example, End-to-end Optimized Image Compression has been proposed, which uses a network based on variational autoencoder. Accordingly, data compression is considered as a fundamental and well-studied problem in engineering, and is commonly formulated with the goal of designing codes for a given discrete data ensemble with minimal entropy. The solution relies heavily on knowledge of the probabilistic structure of the data, and thus the problem is closely related to probabilistic source modeling. However, since all practical codes must have finite entropy, continuous-valued data (such as vectors of image pixel intensities) must be quantized to a finite set of discrete values, which introduces error. In this context, known as the lossy compression problem, one must trade off two competing costs: the entropy of the discretized representation (rate) and the error arising from the quantization (distortion). Different compression applications, such as data storage or transmission over limited-capacity channels, demand different rate-distortion trade-offs. Joint optimization of rate and distortion is difficult. Without further constraints, the general problem of optimal quantization in high-dimensional spaces is intractable. For this reason, most existing image compression methods operate by linearly transforming the data vector into a suitable continuous-valued representation, quantizing its elements independently, and then encoding the resulting discrete representation using a lossless entropy code. This scheme is called transform coding due to the central role of the transformation. For example, JPEG uses a discrete cosine transform on blocks of pixels, and JPEG 2000 uses a multi-scale orthogonal wavelet decomposition. Typically, the three components of transform coding methods—transform, quantizer, and entropy code—are separately optimized (often through manual parameter adjustment). Modern video compression standards like HEVC, VVC and EVC also use transformed representation to code residual signal after prediction. The several transforms are used for that purpose such as discrete cosine and sine transforms (DCT, DST), as well as low frequency non-separable manually optimized transforms (LFNST).

### Variational Image Compression

In J. Balle, L. Valero Laparra, and E. P. Simoncelli (2015). “Density Modeling of Images Using a Generalized Normalization Transformation”. In: arXiv e-prints. Presented at the 4th Int. Conf. for Learning Representations, 2016 (referred to in the following as “Balle”) the authors proposed a framework for end-to-end optimization of an image compression model based on nonlinear transforms. Previously, authors demonstrated that a model consisting of linear-nonlinear block transformations, optimized for a measure of perceptual distortion. exhibited visually superior performance compared to a model optimized for mean squared error (MSE). Here, authors optimize for MSE, but use a more flexible transforms built from cascades of linear convolutions and nonlinearities. Specifically, authors use a generalized divisive normalization (GDN) joint nonlinearity that is inspired by models of neurons in biological visual systems, and has proven effective in Gaussianizing image densities. This cascaded transformation is followed by uniform scalar quantization (i.e., each element is rounded to the nearest integer), which effectively implements a parametric form of vector quantization on the original image space. The compressed image is reconstructed from these quantized values using an approximate parametric nonlinear inverse transform.

For any desired point along the rate-distortion curve, the parameters of both analysis and synthesis transforms are jointly optimized using stochastic gradient descent. To achieve this in the presence of quantization (which produces zero gradients almost everywhere), authors use a proxy loss function based on a continuous relaxation of the probability model, replacing the quantization step with additive uniform noise. The relaxed rate-distortion optimization problem bears some resemblance to those used to fit generative image models, and in particular variational autoencoders, but differs in the constraints authors impose to ensure that it approximates the discrete problem all along the rate-distortion curve. Finally, rather than reporting differential or discrete entropy estimates, authors implement an entropy code and report performance using actual bit rates, thus demonstrating the feasibility of the solution as a complete lossy compression method.

In J. Balle, an end-to-end trainable model for image compression based on variational autoencoders is described. The model incorporates a hyperprior to effectively capture spatial dependencies in the latent representation. This hyperprior relates to side information also transmitted to decoding side, a concept universal to virtually all modern image codecs, but largely unexplored in image compression using ANNs. Unlike existing autoencoder compression methods, this model trains a complex prior jointly with the underlying autoencoder. Authors demonstrate that this model leads to state-of-the-art image compression when measuring visual quality using the popular MS-SSIM index, and yields rate-distortion performance surpassing published ANN-based methods when evaluated using a more traditional metric based on squared error (PSNR).

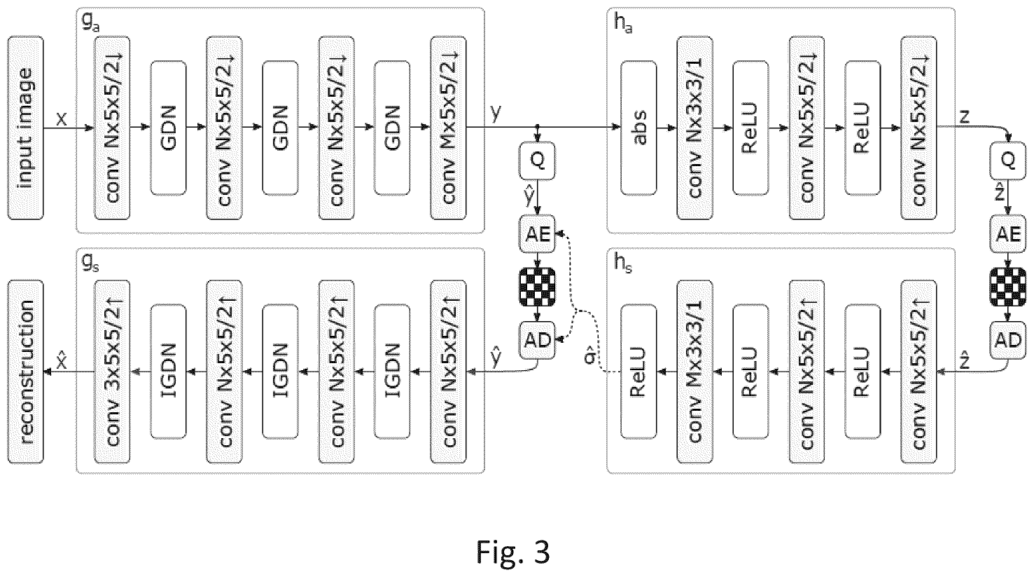

FIG. 3 shows a network architecture including a hyperprior model. The left side (gₐ, gₛ) shows an image autoencoder architecture, the right side (hₐ, hₛ) corresponds to the autoencoder implementing the hyperprior. The factorized-prior model uses the identical architecture for the analysis and synthesis transforms gₐ and gₛ. Q represents quantization, and AE, AD represent arithmetic encoder and arithmetic decoder, respectively. The encoder subjects the input image x to gₐ, yielding the responses y (latent representation) with spatially varying standard deviations. The encoding gₐ includes a plurality of convolution layers with subsampling and, as an activation function, generalized divisive normalization (GDN).

The responses are fed into hₐ, summarizing the distribution of standard deviations in z. z is then quantized, compressed, and transmitted as side information. The encoder then uses the quantized vector \hat{z} to estimate \hat{σ}, the spatial distribution of standard deviations which is used for obtaining probability values (or frequency values) for arithmetic coding (AE), and uses it to compress and transmit the quantized image representation ŷ (or latent representation). The decoder first recovers \hat{z} from the compressed signal. It then uses hₛ to obtain ŷ, which provides it with the correct probability estimates to successfully recover ŷ as well. It then feeds ŷ into gₛ to obtain the reconstructed image.

In further works the probability modelling by hyperprior was further improved by introducing autoregressive model e.g. based on PixelCNN++ architecture, which allows to utilize context of already decoded symbols of latent space for better probabilities estimation of further symbols to be decoded, e.g. like it is illustrated on FIG. 2 of L. Zhou, Zh. Sun, X. Wu, J. Wu, End-to-end Optimized Image Compression with Attention Mechanism, CVPR 2019 (referred to in the following as “Zhou”).

### Cloud Solutions for Machine Tasks

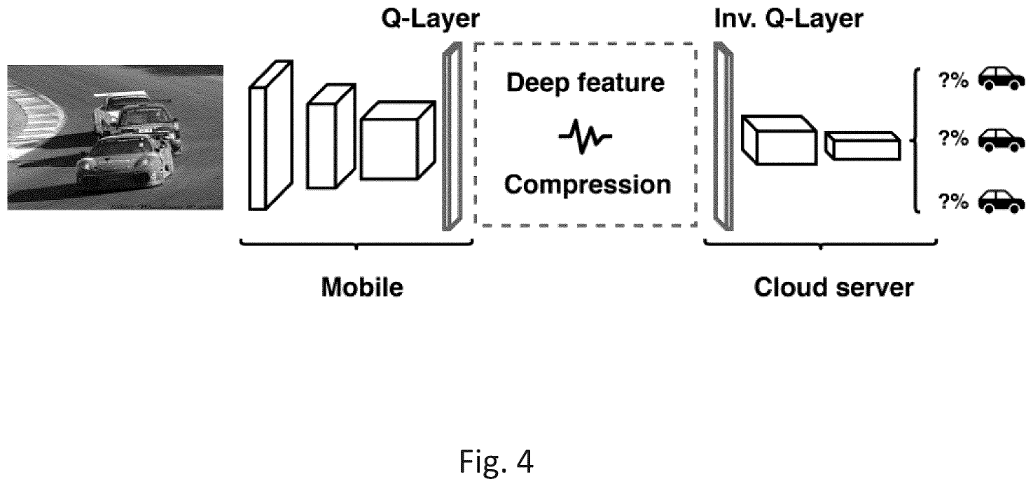

The Video Coding for Machines (VCM) is another computer science direction being popular nowadays. The main idea behind this approach is to transmit the coded representation of image or video information targeted to further processing by computer vision (CV) algorithms, like object segmentation, detection and recognition. In contrast to traditional image and video coding targeted to human perception the quality characteristic is the performance of computer vision task, e.g. object detection accuracy, rather than reconstructed quality. This is illustrated in FIG. 4.

Video Coding for Machines is also referred to as collaborative intelligence and it is a relatively new paradigm for efficient deployment of deep neural networks across the mobile-cloud infrastructure. By dividing the network between the mobile and the cloud, it is possible to distribute the computational workload such that the overall energy and/or latency of the system is minimized. In general, the collaborative intelligence is a paradigm where processing of a neural network is distributed between two or more different computation nodes; for example devices, but in general, any functionally defined nodes. Here, the term “node” does not refer to the above-mentioned neural network nodes. Rather the (computation) nodes here refer to (physically or at least logically) separate devices/modules, which implement parts of the neural network. Such devices may be different servers, different end user devices, a mixture of servers and/or user devices and/or cloud and/or processor or the like. In other words, the computation nodes may be considered as nodes belonging to the same neural network and communicating with each other to convey coded data within/for the neural network. For example, in order to be able to perform complex computations, one or more layers may be executed on a first device and one or more layers may be executed in another device. However, the distribution may also be finer and a single layer may be executed on a plurality of devices. In this disclosure, the term “plurality” refers to two or more. In some existing solution, a part of a neural network functionality is executed in a device (user device or edge device or the like) or a plurality of such devices and then the output (feature map) is passed to a cloud. A cloud is a collection of processing or computing systems that are located outside the device, which is operating the part of the neural network. The notion of collaborative intelligence has been extended to model training as well. In this case, data flows both ways: from the cloud to the mobile during back-propagation in training, and from the mobile to the cloud during forward passes in training, as well as inference.

Some works presented semantic image compression by encoding deep features and then reconstructing the input image from them. The compression based on uniform quantization was shown, followed by context-based adaptive arithmetic coding (CABAC) from H.264. In some scenarios, it may be more efficient, to transmit from the mobile part to the cloud an output of a hidden layer (a deep feature map), rather than sending compressed natural image data to the cloud and perform the object detection using reconstructed images. The efficient compression of feature maps benefits the image and video compression and reconstruction both for human perception and for machine vision. Entropy coding methods, e.g. arithmetic coding is a popular approach to compression of deep features (i.e. feature maps).

Nowadays, video content contributes to more than 80% internet traffic, and the percentage is expected to increase even further. Therefore, it is critical to build an efficient video compression system and generate higher quality frames at given bandwidth budget. In addition, most video related computer vision tasks such as video object detection or video object tracking are sensitive to the quality of compressed videos, and efficient video compression may bring benefits for other computer vision tasks. Meanwhile, the techniques in video compression are also helpful for action recognition and model compression. However, in the past decades, video compression algorithms rely on hand-crafted modules, e.g., block based motion estimation and Discrete Cosine Transform (DCT), to reduce the redundancies in the video sequences, as mentioned above. Although each module is well designed, the whole compression system is not end-to-end optimized. It is desirable to further improve video compression performance by jointly optimizing the whole compression system.

### End-to-End Image or Video Compression

Recently, deep neural network (DNN) based autoencoder for image compression has achieved comparable or even better performance than the traditional image codecs like JPEG, JPEG2000 or BPG. One possible explanation is that the DNN based image compression methods can exploit large scale end-to-end training and highly non-linear transform, which are not used in the traditional approaches. However, it is non-trivial to directly apply these techniques to build an end-to-end learning system for video compression. First, it remains an open problem to learn how to generate and compress the motion information tailored for video compression. Video compression methods heavily rely on motion information to reduce temporal redundancy in video sequences. A straightforward solution is to use the learning based optical flow to represent motion information. However, current learning based optical flow approaches aim at generating flow fields as accurate as possible. The precise optical flow is often not optimal for a particular video task. In addition, the data volume of optical flow increases significantly when compared with motion information in the traditional compression systems and directly applying the existing compression approaches in to compress optical flow values will significantly increase the number of bits required for storing motion information. Second, it is unclear how to build a DNN based video compression system by minimizing the rate-distortion based objective for both residual and motion information. Rate-distortion optimization (RDO) aims at achieving higher quality of reconstructed frame (i.e., less distortion) when the number of bits (or bit rate) for compression is given. RDO is important for video compression performance. In order to exploit the power of end-to-end training for learning based compression system, the RDO strategy is required to optimize the whole system.

In Guo Lu, Wanli Ouyang, Dong Xu, Xiaoyun Zhang, Chunlei Cai, Zhiyong Gao;, DVC: An End-to-end Deep Video Compression Framework“. Proceedings of the IEEE/CVF Conference on Computer Vision and Pattern Recognition (CVPR), 2019. pp. 11006-11015. authors proposed the end-to-end deep video compression (DVC) model that jointly learns motion estimation, motion compression, and residual coding.

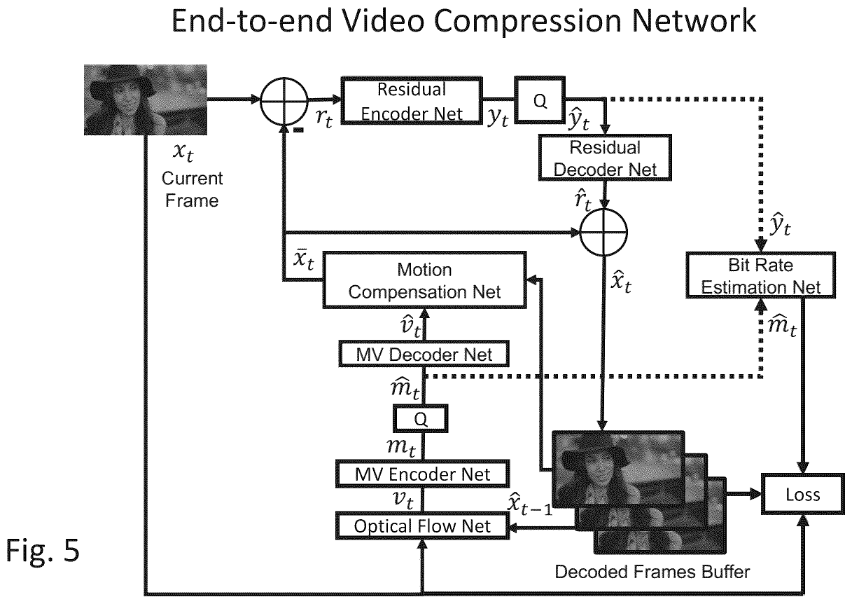

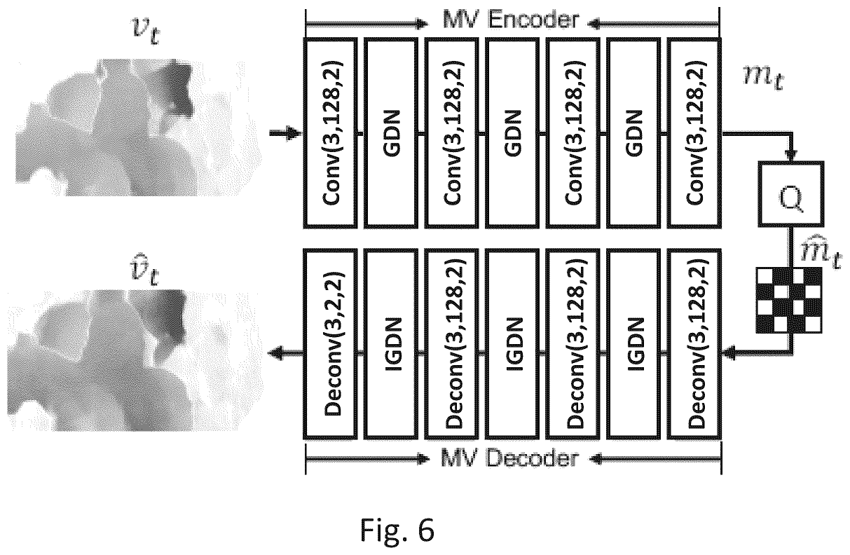

Such encoder is illustrated in FIG. 5. In particular, FIG. 5 shows an overall structure of end-to-end trainable video compression framework. In order to compress motion information, a CNN was designated to transform the optical flow to the corresponding representations suitable for better compression. Specifically, an auto-encoder style network is used to compress the optical flow. The motion vectors (MV) compression network is shown in FIG. 6. The network architecture is somewhat similar to the ga/gs of FIG. 3. In particular, the optical flow is fed into a series of convolution operation and nonlinear transform including GDN and IGDN. The number of output channels for convolution (deconvolution) is 128 except for the last deconvolution layer, which is equal to 2. Given optical flow with the size of M×N×2, the MV encoder will generate the motion representation with the size of M/16×N/16×128. Then motion representation is quantized, entropy coded and sent to bitstream. The MV decoder receives the quantized representation and reconstruct motion information using MV encoder.

Particularly, the following definitions hold.

Picture size (Image size; the terms “image” and “picture” are used interchangeably, herein): refers to the width or height or the width-height pair of a picture. Width and height of an image is usually measured in number of luma samples.

Down-sampling: down-sampling is a process, where the sampling rate (sampling interval) of the discrete input signal is reduced.

Up-sampling: up-sampling is a process, where the sampling rate (sampling interval) of the discrete input signal is increased.

Cropping: Trimming off the outside edges of a digital image. Cropping can be used to make an image smaller (in number of samples) and/or to change the aspect ratio (length to width) of the image.

Padding: padding refers to increasing the size of the input image (or image) by generating new samples at the borders of the image by either using sample values that are predefined or by using sample values of the positions in the input image.

Convolution: convolution is given by the following general equation. Below f( ) can be defined as the input signal and g( ) can be defined as the filter.

$$( f * g ) [ n ] = {\sum }_{m = - ∞}^{∞} f [ m ] g [ n - m ]$$

NN module: neural network module, a component of a neural network. It could be a layer or a sub-network in a neural network. Neural network is a sequence of NN modules.

Within the context of this document it's supposed that Neural network is a sequence of K NN modules.

Latent space: intermediate steps of neural network processing, latent space representation include output of input layer or hidden layer(s), they are not supposed to be viewed

Lossy NN module: information processed by a lossy NN module results in information lose, lossy module make its processed information not revertible

Lossless NN module: information processed by a lossless NN module results in no information lose, lossless make its processed information revertible

Bottleneck: latent space tensor which goes to lossless coding module

Auto-encoder: The model which transforms signal into a (compressed) latent space and transforms back to the original signal space

Encoder: Down-samples the image with convolutional layers with non-linearity and/or residuals to a latent tensor (y)

Decoder: Up-samples the latent tensor (y) with convolutional layers with non-linearity and/or residuals to original image size

Hyper-Encoder: Down-samples the latent tensor further with convolutional layers with non-linearity and/or residuals to a smaller latent tensor (z)

Hyper-Decoder: Up-samples the smaller latent tensor (z) with convolutional layers with non-linearity and/or residuals for the entropy estimation.

AE/AD (Arithmetic Encoder/Decoder): encodes the latent tensor into bitstream or decodes the latent tensor from the bits-stream with given statistical priors

Autoregressive Entropy Estimation: The process of estimation of the statistical priors of the latent tensor sequentially
Q: a quantization block.
ŷ, \hat{z}: the quantized version of corresponding latent tensors.

Masked Convolution (MaskedConv): a type of convolution which masks certain latent tensor elements so that the model can only predict based on latent tensor elements already seen.

H,W: height and width of the input image

Block/Patch: Subset of a latent tensor on a rectangular grid

Information Share: Process of cooperative process of information from different patches
P: the size of the rectangular patch
K: the kernel size which defines the number neighboring patches that are included in the information share
L: the kernel size which defines how many of the previously coded latent tensor elements are included in the information share

Masked Convolution (MaskedConv): a type of convolution which masks certain latent tensor elements so that the model can only predict based on latent tensor elements already seen.

PixelCNN: Convolutional neural network containing one or multiple layers of Masked Convolutions.

Component: one dimension of the orthogonal basis which describes a full color image

Channel: layer in the neural network.

Intra codec: the first frame or the key frame of the video will be process as intra frame, usually it is processed as image.

Inter codec: after intra codec the video compression system will do inter prediction. First motion estimation tool will calculate the motion vectors of the objects, then the motion compensation tool will use the motion vector to predict the next frame.

Residual codec: the predicted frame is not always identical with the current frame, the difference between the current frame and predicted frame is the residual. Residual codec will compress the residual like compressing image.

Signal conditioning: training procedure in which additional signal is used to help with the NN inference, but the additional signal is not present in, and is very different from the output.

Conditional codec: A codec which uses signal conditioning to aid (guide) the compression and reconstruction. Since the auxiliary information needed for conditioning is not part of the input signal, in SOTA, conditional codec is used for compression of video streams, and not of images.

The following references give details on several aspects of coding of the art.

Ballé, Johannes, Valero Laparra, and Eero P. Simoncelli in a paper entitled “End-to-end optimized image compression”, 5th International Conference on Learning Representations, ICLR 201, 2017 teach learned image compression.

Ballé, Johannes, et al. in a paper entitled “Variational image compression with a scale hyperprior”, International Conference on Learning Representations, 2018, teach the hyper-prior model.

Minnen, David, Johannes Ballé, and George Toderici in a paper entitled “Joint Autoregressive and Hierarchical Priors for Learned Image Compression”, NeurIPS, 2018, teach serial autoregressive context modelling.

Théo Ladune, Pierrick Philippe, Wassim Hamidouche, Lu Zhang and Olivier Dé forges in a paper entitled “Optical Flow and Mode Selection for Learning-based Video Coding.” IEEE 22nd International Workshop on Multimedia Signal Processing (MMSP), 2020, teach a conditional coded.

Guo Lu, Wanli Ouyang, Dong Xu, Xiaoyun Zhang, Chunlei Cai, and Zhiyong Gao in a paper entitled “DVC: An End-to-end Deep Video Compression Framework”, CVPR 2019, 2019, teach a deep neural network based video codec.

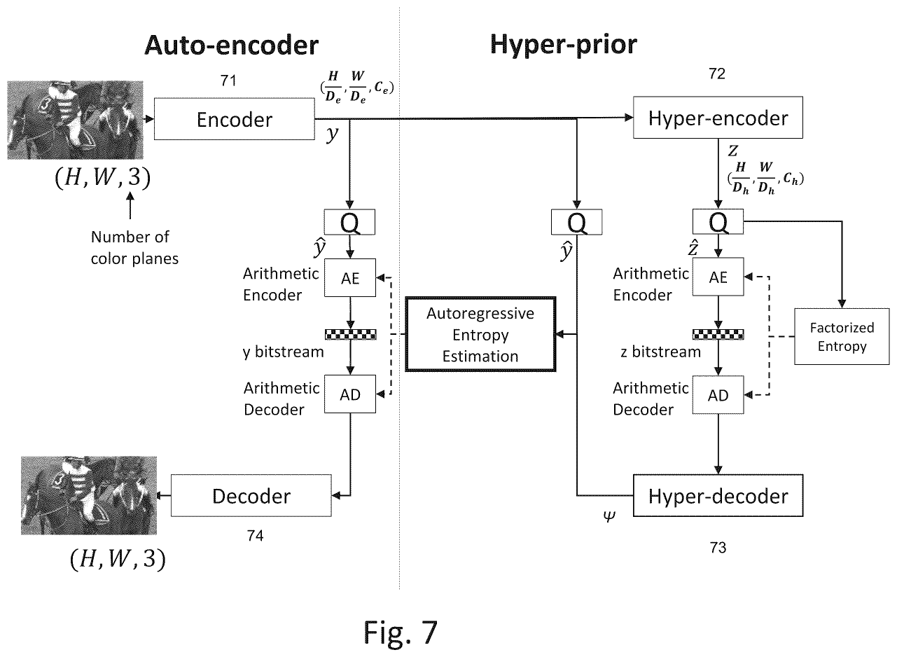

FIG. 7 is a block diagram that illustrates a particular learned image compression configuration comprising an auto-encoder and a hyper-prior component of the art that can be improved according to the present disclosure. The input image to be compressed is represented as a 3D tensor with the size of H×W×C wherein H and W are the height and width (dimensions) of the image, respectively, and C is the number of components (for example, a luma component and two chroma components). The input image is passed through an encoder 71. The encoder down-samples the input image by applying multiple convolutions and non-linear transformations, and produces a latent tensor y. It is noted that in the context of deep learning the terms “down-sampling” and “up-sampling” do not refer to re-sampling in the classical sense but rather are the common terms for changing the size of the H and W dimensions of the tensor. The latent tensor y output by the encoder 71 represents the image in latent space and has the size of

$$\frac{H}{{D}_{e}} \times \frac{W}{{D}_{e}} \times {C}_{e} ,$$

wherein Dₑ is the down-sampling factor of the encoder 71 and Cₑ is the number of channels (for example, the number of neural network layers involved in the transformation of the tensor representing the input image).

The latent tensor y is further down-sampled by a hyper-encoder 72 by means of convolutions and non-linear transforms into a hyper-latent tensor z. The hyper-latent tensor z has the size

$$\frac{H}{{D}_{h}} \times \frac{W}{{D}_{h}} \times {C}_{h} .$$

The hyper-latent tensor \hat{z} is quantized by the block Q in order to obtain a quantized hyper-latent tensor \hat{z}. Statistical properties of the values of the quantized hyper-latent tensor \hat{z} are estimated by means of a factorized entropy model. An arithmetic encoder AE uses these statistical properties to create a bitstream representation of the tensor \hat{z}. All elements of tensor \hat{z} are written into the bitstream without the need of an autoregressive process.

The factorized entropy model works as a codebook whose parameters are available on the decoder side. An arithmetic-decoder AD recovers the hyper-latent tensor \hat{z} from the bitstream by using the factorized entropy model. The recovered hyper-latent tensor \hat{z} is up-sampled by a hyper-decoder 73 by applying multiple convolution operations and non-linear transformations. The up-sampled recovered hyper-latent tensor is denoted by ψ. The entropy of the quantized latent tensor ŷ is estimated autoregressively based on the up-sampled recovered hyper-latent tensor ψ. The thus obtained autoregressive entropy model is used to estimate the statistical properties of the quantized latent tensor \hat{z}.

An arithmetic encoder AE uses these estimated statistical properties to create a bitstream representation of the quantized latent tensor \hat{z}. In other words, the arithmetic encoder AE of the auto-encoder component compresses the image information in latent space by entropy encoding based on side information provided by the hyper-prior component. The latent tensor y is recovered from the bitstream by an arithmetic decoder AD on the receiver side by means of the autoregressive entropy model. The recovered latent tensor y is up-sampled by a decoder 74 by applying multiple convolution operations and non-linear transformations in order to obtain a tensor representation of a reconstructed image.

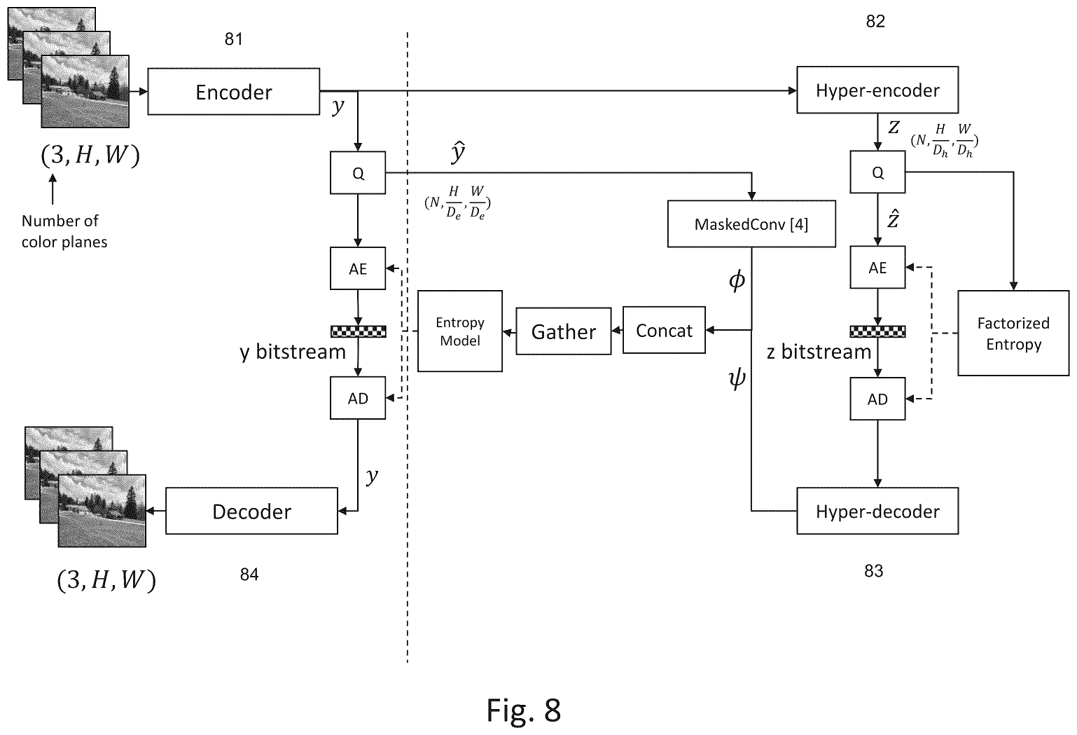

FIG. 8 shows a modification of the architecture shown in FIG. 7. Processing of the encoder 81 and decoder 84 of the auto-encoder component is similar to the processing of the encoder 71 and decoder 74 of the auto-encoder component shown in FIG. 7 and processing of the encoder 82 and decoder 83 of the hyper-prior component is similar to the processing of the encoder 72 and decoder 73 of the hyper-prior component shown in FIG. 7. It is noted that each of these encoders 71, 81, 72, 82 and decoders 73, 83, 74, 84 may, respectively, comprise or be connected to a neural network. Further, neural networks may be used to provide the entropy models involved.

Different from the configuration shown in FIG. 7, in the configuration shown in FIG. 8 the quantized latent tensor \hat{z} is subject to masked convolution to obtain the tensor Φ with a reduced number of elements as compared to \hat{z}. The entropy model is obtained based on concatenated tensors Φ and ψ (the up-sampled recovered hyper-latent tensor). The thus obtained entropy model is used to estimate the statistical properties of the quantized latent tensor ŷ.

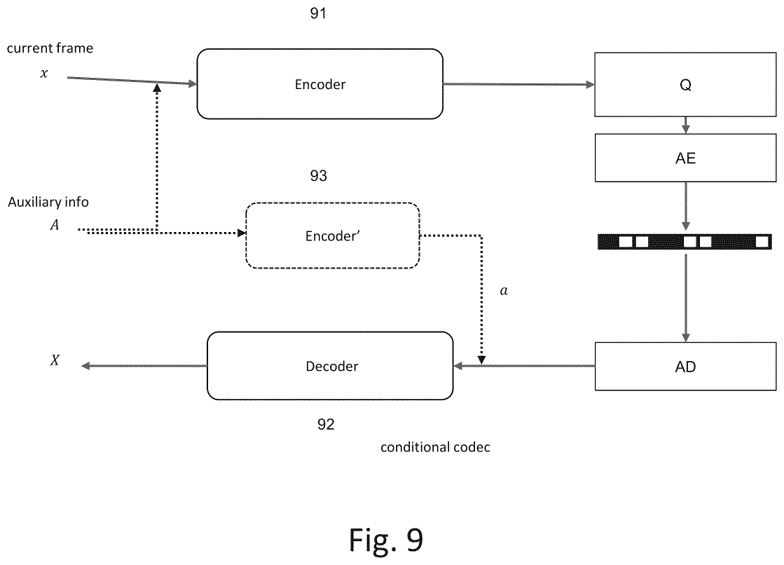

Conditional coding represents a particular kind of coding wherein auxiliary information is used in order to improve the quality of a reconstructed image. FIG. 9 illustrates the principle idea of conditional coding. Auxiliary information A is concatenated with an input frame x and jointly processed by an encoder 91. The quantized encoded information in latent space is written into a bitstream by an arithmetic encoder and recovered from the bitstream by an arithmetic decoder AD. The recovered encoded information in latent space has to be decoded by a decoder 92 to obtain a reconstructed frame X. In this decoding stage, a latent representation a of the auxiliary information A needs to be added to the input of the decoder 92. The latent representation a of the auxiliary information A is provided by another encoder 93 and it is concatenated with the output of the decoder 92.

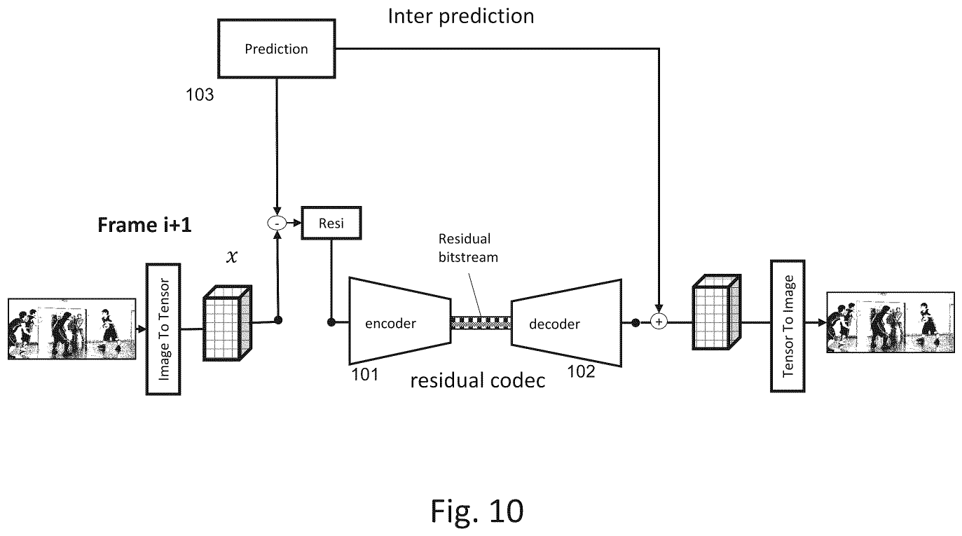

In the context of video compression, a conditional codec is implemented for compressing residuals used for inter prediction of a current block of a current frame as it is illustrated in FIG. 10. The residual is calculated by subtracting a current block from its predicted version. The residual is encoded by an encoder 101 in order to obtain a residual bitstream. The residual bitstream is decoded by a decoder 102. The prediction block is obtained by a prediction unit 103 by using information from a previous frame/block. Since the prediction block has the same size and dimension as the current block, it is processed in a similar way. The reconstructed residual is added to the prediction block to provide the reconstructed block.

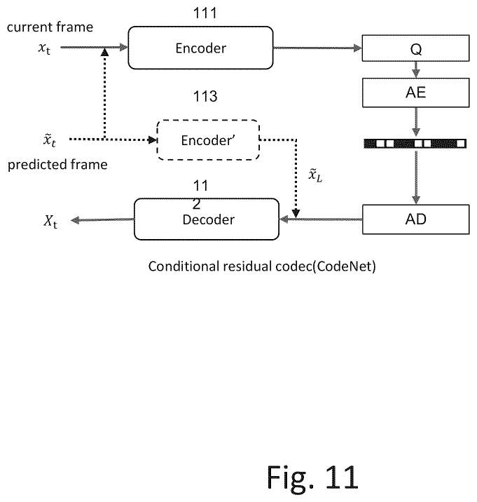

Conditional residual coding (CodeNet) of the art is illustrated in FIG. 11. The configuration is similar to the one shown in FIG. 9. A conditional encoder 111 is used for encoding a current frame xₜ by using information from a predicted frame \tilde{x}ₜ as auxiliary information for conditioning the codec. The quantized encoded information in latent space is written into a bitstream by an arithmetic encoder and recovered from the bitstream by an arithmetic decoder AD. The recovered encoded information in latent space is decoded by a decoder 112 to obtain a reconstructed frame Xₜ. In this decoding stage, a latent representation \tilde{x}_{L} of the auxiliary information \tilde{x}ₜ needs to be added to the input of the decoder 112. The latent representation \tilde{x}_{L} of the auxiliary information \tilde{x}ₜ is provided by another encoder 113 and it is concatenated with the output of the decoder 112.

CodeNet uses the predicted frame, but does not use the explicit difference between the predicted and current frames (residuals). Coding the current frame while retrieving all information from the predicted frame can advantageously result in less information to be transmitted as compared to residual coding.

However, CodeNet due to the involved entropy prediction does not allow for highly parallel processing and, furthermore, it demands for a large memory space. According to the present disclosure, memory demands can be reduced and runtime of the overall processing can be improved.

The present disclosure provides conditional coding wherein a primary component of an image is encoded independently from one or more non-primary components and the one or more non-primary components are encoded using information from the primary component. Here and in the following, the primary component may be a luma component and the one or more non-primary components may be chroma components or the primary component may be a chroma component and the single non-primary component may be a luma component. The primary component can be encoded and decoded independently from the non-primary component(s). Thus, it can be decoded even in the case that the non-primary component(s) is (are) lost for some reason. The one or more non-primary components can be encoded jointly and concurrently and they can be encoded concurrently with the primary component. Decoding of the one or more non-primary components makes use of information from the latent representation of the primary component. This kind of conditional coding can be applied to intra prediction and inter prediction processing of a video sequence. Moreover, it can be applied to still image coding.

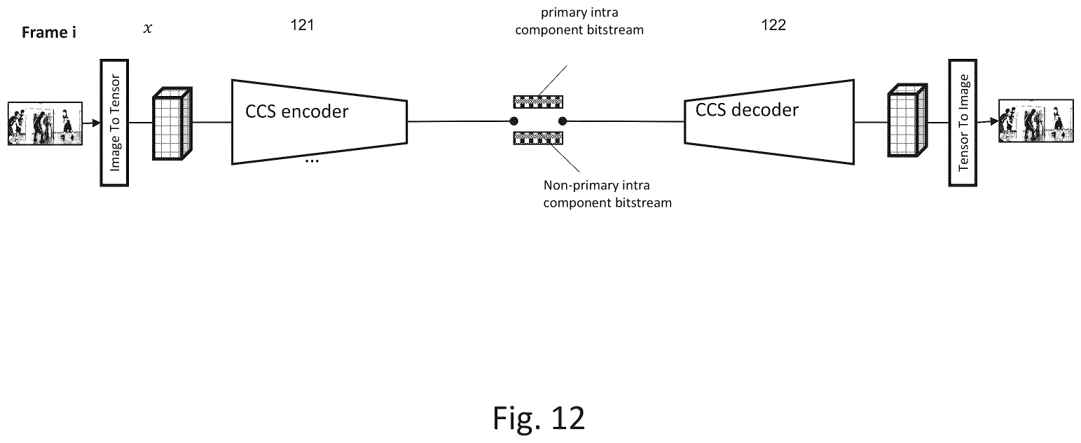

FIG. 12 illustrates basics of conditional intra prediction according to an exemplary embodiment. A tensor representation x of an input image/frame i is quantized and supplied to an encoding device 121. It is noted that here and in the following description an entire image or a portion of an image only, for example, one or more blocks, slices, tiles, etc., can be coded.

In a pre-stage of the encoding device 121 separation of the tensor representation x into a primary intra component and at least one non-primary (secondary) intra component is performed and the primary intra component is converted into a primary intra component bitstream and the at least one non-primary intra component is converted into at least one non-primary intra component bitstream. The bitstreams represent compressed information on the components used by a decoding device 122 for reconstruction of the components. The two bitstreams can be interleaved with each other. The encoding device 121 may be addressed as a conditional color separation (CCS) encoding device. Encoding of the at least one non-primary intra component is based on information from the primary intra component as will be described in detail later on. The respective bitstreams are decoded by the decoding device 122 in order to reconstruct the image/frame. Decoding of the at least one non-primary intra component is based on information from the latent representation of the primary intra component as will be described in detail later on.

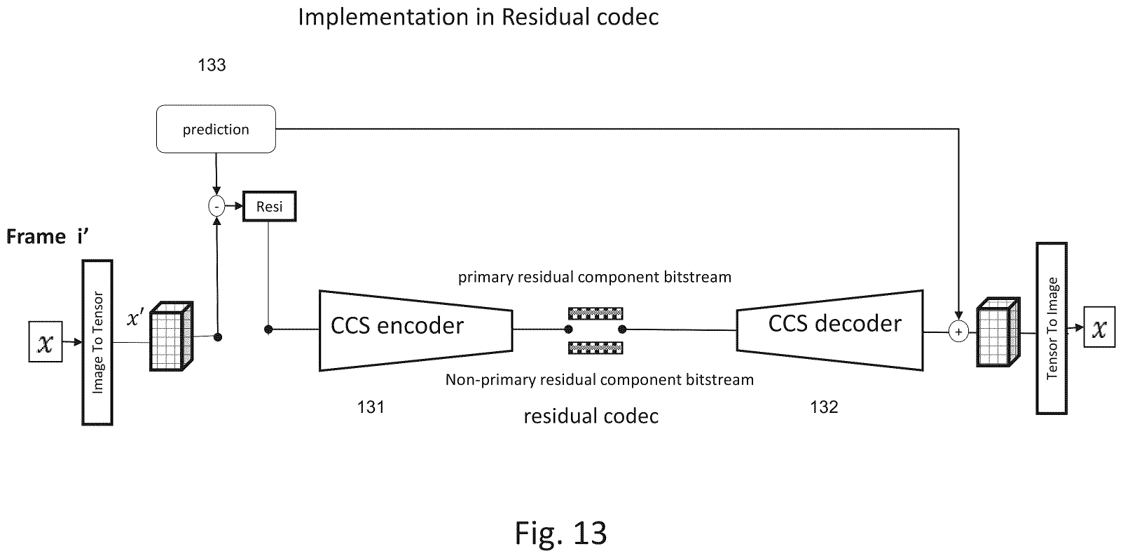

FIG. 13 illustrates basics of residual coding according to an exemplary embodiment. A tensor representation x′ of an input image/frame i′ is quantized and the residual is calculated and supplied to an encoding device 131. In a pre-stage of the encoding device 131 separation of the residual into a primary residual component and at least one non-primary residual component is performed and the primary residual component is converted into a primary residual component bitstream and the at least one non-primary residual component is converted into at least one non-primary residual component bitstream. The encoding device 131 may be addressed as a conditional color separation (CCS) encoding device. Encoding of the at least one non-primary residual component is based on information from the primary residual component as will be described in detail later on. The respective bitstreams are decoded by a decoding device 132 in order to reconstruct the image/frame. Decoding of the at least one non-primary residual component is based on information from the latent representation of the primary residual component as will be described in detail later on. The prediction needed for the calculation of the residual and the reconstructed image/frame is provided by a prediction unit 133.

In the configurations shown in FIGS. 12 and 13 the encoding devices 121 and 131 and the decoding devices 131 and 132 may comprise or be connected to respective neural networks. The encoding devices 121 and 131 may comprise Variational Autoencoders. Different number of channels/neural network layers may be involved in processing the primary component as compared to processing the at least one non-primary component. The encoding devices 121 and 131 may determine the appropriate number of channels/neural network layers by performing exhaustive search or in a content-adaptive manner. A set of models may be trained wherein each model is based on a different number of channels for encoding of the primary and non-primary components. During processing, the best performing filter may be determined by the encoding devices 121 and 131. Neural networks of the encoding devices 121 and 131 may be cooperatively trained in order to determine the number of channels used for processing the primary and non-primary component(s). In some applications, the number of channels used for processing the primary component may be larger than the number of channels used for processing the non-primary component(s). In other application, for example, if the signal of the primary component is less noisy than the one of the non-primary component(s), the number of channels used for processing the primary component may be smaller than the number of channels used for processing the non-primary component(s). In principle, the choice of the numbers of channels may result from an optimization with respect to the processing rate, on the one hand, and signal distortion, on the other hand. Extra channels may reduce distortions but result in a higher processing load. Experiments have shown that suitable numbers of channels may, for example, be 128 for the primary component and 64 for the non-primary component, or 128 for both the primary component and the non-primary component, or 192 for the primary component and 64 for the non-primary component.

The number of channels/neural network layers used for the encoding process may be implicitly or expressly signaled to the decoding devices 122 and 132, respectively.

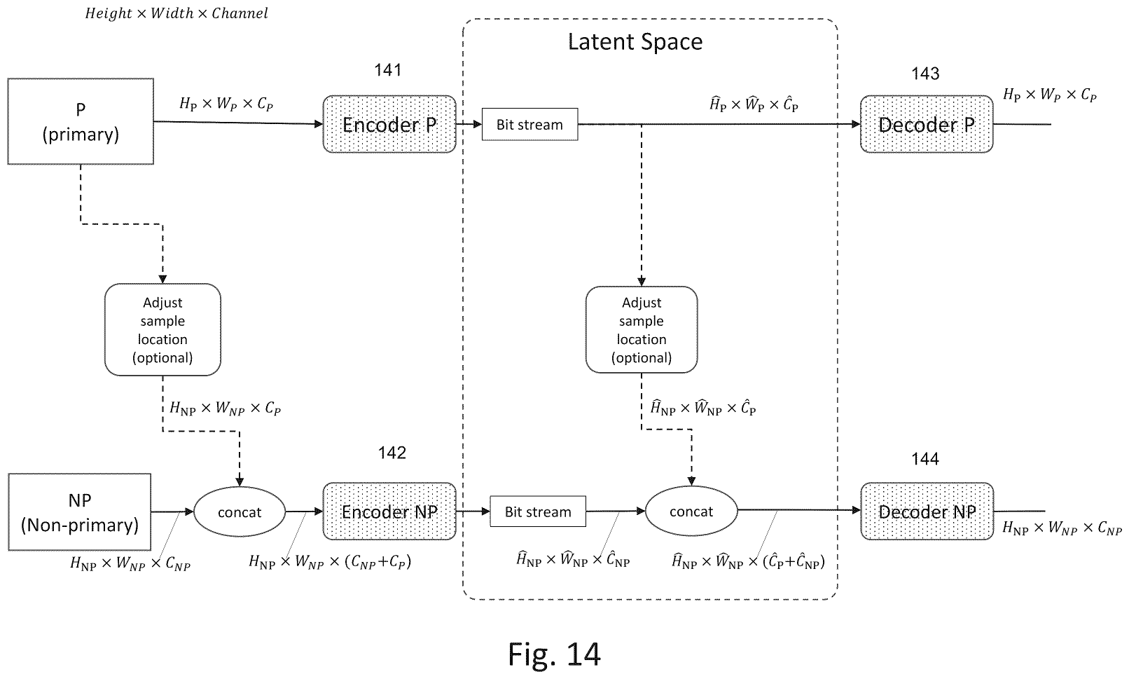

FIG. 14 illustrates an embodiment of conditional coding of an image (frame of a video sequence or a still image) in some more details. An encoder 141 receives a tensor representation with the size H_{P}×W_{P}×C_{P} of a primary component P of the image, wherein H_{P} denotes the height dimension of the image, W_{P} denotes the width dimension of the image and C_{P} denotes the input channel dimension. In the following, a tensor with a size of A×B×C is usually simply quoted as a tensor A×B×C for short.

Exemplary sizes in the height, width and channel dimensions of the tensor output by the encoder 141 are HP/16×WP/16×128.

It is noted that the encoders 141 and 142 may be comprised in the encoding devices 121 and 131.

Based on the output of the encoder 141, i.e., a representation of the tensor representation of the primary component of the image in latent space, a bitstream is generated and converted back into the latent space to obtain the recovered tensor in latent space Ĥ_{P}×Ŵ_{P}×Ĉ_{P}.

A tensor representation H_{NP}×W_{NP}×C_{NP} of at least one non-primary component NP of the image, wherein H_{NP} denotes the height dimension of the image, W_{NP} denotes the width dimension of the image and C_{NP} denotes the input channel dimension, is input into another encoder 142 after concatenation with the tensor representation H_{P}×W_{P}×C_{P} of the primary component P (thus, a tensor H_{NP}×W_{NP}×(C_{NP}+C_{P}) is input into the other encoder 142. Exemplary sizes in the height, width and channel dimensions of the tensor output by the encoder 142 are H_{P}/16×W_{P}/16×64 or H_{P}/32×W_{P}/32×64.

Before concatenation the sample locations of the tensor representation H_{P}×W_{P}×C_{P} of the primary component P may have to be adjusted to the ones of the tensor representation H_{NP}×W_{NP}×C_{NP} of the at least one non-primary component NP, if the size or sub-pixel offset of samples of the tensors differs from each other. Based on the output of the other encoder 142, i.e., a representation of the concatenated tensor image in latent space, a bitstream is generated and converted back into the latent space to obtain the recovered concatenated tensor in latent space Ĥ_{P}×Ŵ_{P}×Ĉ_{P}.

On the primary side, the recovered tensor in latent space Ĥ_{P}×Ŵ_{P}×Ĉ_{P} is input into a decoder 143 for reconstruction of the primary component P of the image based on the reconstructed tensor representation H_{P}×W_{P}×C_{P}.

Further, in latent space the concatenation of the tensor Ĥ_{NP}×Ŵ_{NP}×Ĉ_{NP} With the tensor Ĥ_{P}×Ŵ_{P}×Ĉ_{P} is performed. Again, some adjustment of sample location is needed, if the size or sub-pixel offset of samples of these tensors to be concatenated differs from each other. On the non-primary side, the tensor Ĥ_{NP}×Ŵ_{NP}×(Ĉ_{P}+Ĉ_{NP}) resulting from this concatenation is input into another decoder 144 for reconstruction of the at least one non-primary component NP of the image based on the reconstructed tensor representation H_{NP}×W_{NP}×C_{NP}.

The above-described coding may be performed for the primary component P independently from the at least one non-primary component NP. For example, the coding of primary component P and the at least one non-primary component NP may be performed concurrently. As compared to the art, parallelization of the overall processing can be increased. Furthermore, numerical experiments have shown that shorter channel lengths as compared to the art can be used without significant degradation of the quality of the reconstructed image and, therefore, memory demands can be reduced.

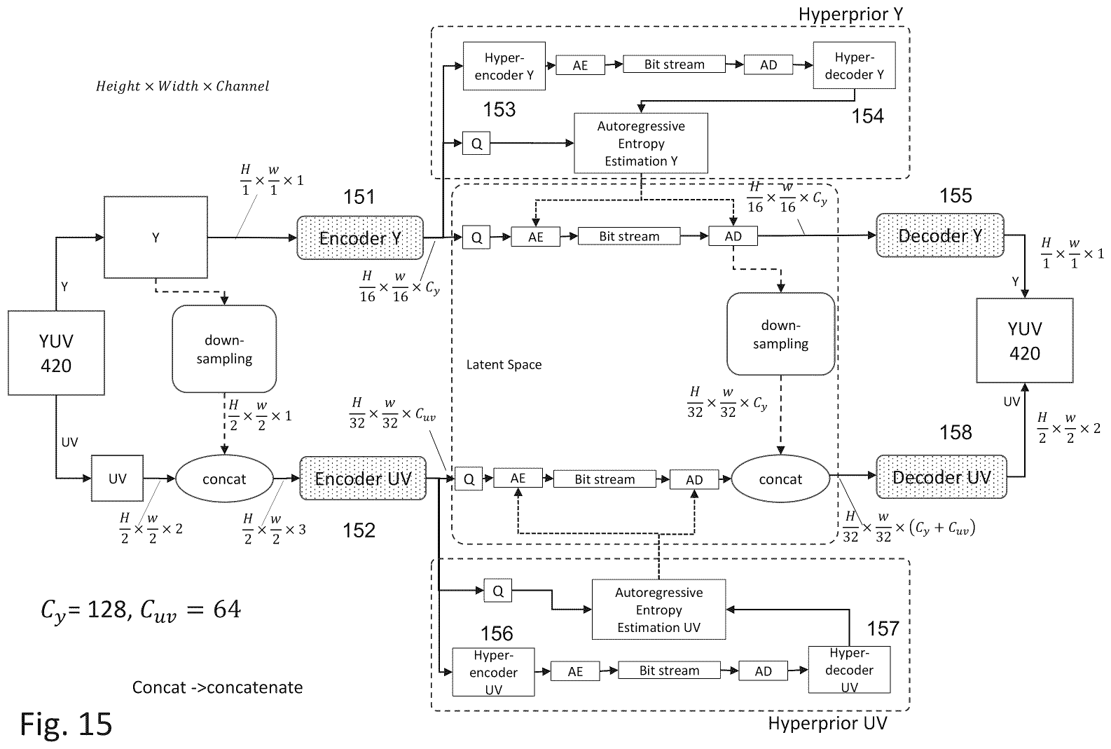

In the following, exemplary implementations of the conditional coding of components of an image represented in YUV space (one luma component Y and two chroma components U and V) are described with reference to FIGS. 15 to 20. It goes without saying that the disclosed conditional coding is also applicable to any other (color) space that might be used for the representation of an image.

In the embodiment illustrated in FIG. 15, input data in the YUV420 format is processed, wherein Y denotes the luma component of a current image to be processed, UV denotes the chroma component U and the chroma component V of the current image to be processed, and 420 indicates that the size of the luma component Y in the height and width dimensions is 4 times bigger than that of the chroma components UV (2 times the height and 2 times the width). In the embodiment illustrated in FIG. 15, Y is selected to be the primary component that is processed independently from UV and UV are selected to be the non-primary components. The UV components are processed together.

A YUV representation of an image to be processed is separated into the (primary) Y component and the (non-primary) UV components. An encoder 151 comprising a neural network receives a tensor representing the Y component of the image that is to be processed with the size of

$$\frac{H}{1} \times \frac{W}{1} \times 1 ,$$

wherein H, W are the height and width dimensions and the depth of the input (i.e., the number of channels) is 1 (for one luma component). The output of the encoder 151 is a latent tensor with the size of

$$\frac{H}{16} \times \frac{W}{16} \times {C}_{y} ,$$

wherein C_{y} is the number of the channels assigned to the Y component. In this embodiment, 4 down-sampling layers in the encoder 151 decrease (down-sample) both the height and the width of the input tensor by a factor of 16 and the number of channels C_{y} is 128. The resulting latent representation of the Y component is processed by a Hyperprior Y pipeline.

The UV components of the image to be processed are represented by a tensor

$$\frac{H}{2} \times \frac{W}{2} \times 2 , ,$$

wherein again H, W are the height and width dimensions and the number of channels is 2 (for two chroma components). Conditional encoding of the UV components requires auxiliary information from the Y component. If the planar sizes (H and W) of the Y component differ from the sizes of the UV components, a resampling unit is used to align the positions of the samples in the tensor representing the Y component with the positions of the samples in the tensor representing the UV components. Similarly, alignment has to be performed, if there are offsets between the positions of the samples in the tensor representing the Y component and the positions of the samples in the tensor representing the UV components.

The aligned tensor representation of the Y component is concatenated with the tensor representation of the UV components to obtain a tensor

$$\frac{H}{2} \times \frac{W}{2} \times 3 .$$

An encoder 152 comprising a neural network transforms this concatenated tensor into a latent tensor

$$\frac{H}{32} \times \frac{W}{32} \times {C}_{u v} ,$$

where Cᵤᵥ is the number of channels assigned to the UV components. In this embodiment, 5 down-sampling layers in the encoder 152 decrease (down-sample) both the height and the width of the input tensor by a factor of 32 and the number of channels is 64. The resulting latent representation of the UV components is processed by a Hyperprior UV pipeline analogous to the Hyperprior Y pipeline (for operation of the pipelines see also description of FIG. 7 above). It is noted that both the Hyperprior UV pipeline and the Hyperprior Y pipeline may comprise neural networks.

The Hyperprior Y pipeline provides an entropy model used for entropy coding of the (quantized) latent representation of the Y component. The Hyperprior Y pipeline comprises a (hyper) encoder 153, an arithmetic encoder, an arithmetic decoder, and a (hyper) decoder 154.

The latent tensor

$$\frac{H}{16} \times \frac{W}{16} \times {C}_{y}$$

representing the Y component in latent space is further down-sampled by the (hyper) encoder 153 by means of convolutions and non-linear transforms to obtain a hyper-latent tensor that (possibly after quantization, not shown in FIG. 15; in fact, here and in the following any quantization performed by quantization units Q is optional) is converted into a bitstream by the arithmetic encoded AE. Statistical properties of the (quantized) hyper-latent tensor are estimated by means of an entropy model, for example, a factorized entropy model, and the arithmetic encoder AE of the Hyperprior Y pipeline uses these statistical properties to create the bitstream. All elements of the (quantized) hyper-latent tensor might be written into the bitstream without the need of an autoregressive process.

The (factorized) entropy model works as a codebook whose parameters are available on the decoder side. The arithmetic-decoder AD of the Hyperprior Y pipeline recovers the hyper-latent tensor from the bitstream by using the (factorized) entropy model. The recovered hyper-latent tensor is up-sampled by the (hyper) decoder 154 by applying multiple convolution operations and non-linear transformations. The latent tensor

$$\frac{H}{16} \times \frac{W}{16} \times {C}_{y}$$

representing the Y component in latent space is subject to quantization by the quantization unit Q of the Hyperprior Y pipeline and the entropy of the quantized latent tensor is estimated autoregressively based on the up-sampled recovered hyper-latent tensor output by the (hyper) decoder 154.

The latent tensor

$$\frac{H}{16} \times \frac{W}{16} \times {C}_{y}$$

representing the Y component in latent space is also quantized before it is converted into a bitstream (that might be transmitted from a transmitter sider to a receiver side) by another arithmetic encoder AE that uses the estimated statistical properties of that tensor provided by Hyperprior Y pipeline. The latent tensor

$$\frac{H}{16} \times \frac{W}{16} \times {C}_{y}$$

is recovered from the bitstream by another arithmetic decoder AD by means of the autoregressive entropy model provided by the Hyperprior Y pipeline. The recovered latent tensor

$$\frac{H}{16} \times \frac{W}{16} \times {C}_{y}$$

is up-sampled by a decoder 155 by applying multiple convolution operations and non-linear transformations in order to obtain a tensor representation of the reconstructed Y component of the image with the size of

$$\frac{H}{1} \times \frac{W}{1} \times 1.$$

The Hyperprior UV pipeline processes the output of the encoder 152, i.e., the latent tensor

$$\frac{H}{32} \times \frac{W}{32} \times {C}_{u v} .$$

This latent tensor is further down-sampled by a (hyper) encoder 156 of the Hyperprior UV pipeline by means of convolutions and non-linear transforms to obtain a hyper-latent tensor that (possibly after quantization, not shown in FIG. 15) is converted into a bitstream by an arithmetic encoded AE of the Hyperprior UV pipeline. Statistical properties of the (quantized) hyper-latent tensor are estimated by means of an entropy model, for example, a factorized entropy model and the arithmetic encoder AE of the Hyperprior Y pipeline uses these statistical properties to create the bitstream. All elements of the (quantized) hyper-latent tensor might be written into the bitstream without the need of an autoregressive process.

The (factorized) entropy model works as a codebook whose parameters are available on the decoder side. An arithmetic-decoder AD of the Hyperprior UV pipeline recovers the hyper-latent tensor from the bitstream by using the (factorized) entropy model. The recovered hyper-latent tensor is up-sampled by the (hyper) decoder 157 of the Hyperprior UV pipeline by applying multiple convolution operations and non-linear transformations. The latent tensor

$$\frac{H}{32} \times \frac{W}{32} \times {C}_{u v}$$

representing the UV components is subject to quantization by the quantization unit Q of the Hyperprior UV pipeline and the entropy of the quantized latent tensor is estimated autoregressively based on the up-sampled recovered hyper-latent tensor output by the (hyper) decoder 157.

The latent tensor

$$\frac{H}{32} \times \frac{W}{32} \times {C}_{u v}$$

representing the UV components in latent space is also quantized before it is converted into a bitstream (that might be transmitted from a transmitter sider to a receiver side) by another arithmetic encoder AE that uses the estimated statistical properties of that tensor provided by Hyperprior UV pipeline. The latent tensor

$$\frac{H}{32} \times \frac{W}{32} \times {C}_{u v}$$

representing the UV components in latent space is recovered from the bitstream by another arithmetic decoder AD by means of the autoregressive entropy model provided by the Hyperprior UV pipeline.

The recovered latent tensor

$$\frac{H}{32} \times \frac{W}{32} \times {C}_{u v}$$

representing the UV components in latent space is concatenated with the recovered latent tensor

$$\frac{H}{16} \times \frac{W}{16} \times {C}_{y}$$

after down-sampling of the later, i.e., the recovered latent tensor

$$\frac{H}{32} \times \frac{W}{32} \times {C}_{u v}$$

is concatenated with the tensor

$$\frac{H}{32} \times \frac{W}{32} \times {C}_{y}$$

(as auxiliary information needed for decoding of the UV components) to obtain the tensor

$$\frac{H}{32} \times \frac{W}{32} \times ( {C}_{y} + {C}_{u v} )$$

that is input into a decoder 158 on the UV processing side and up-sampled by that decoder 158 by applying multiple convolution operations and non-linear transformations in order to obtain a tensor representation of the reconstructed UV components of the image with the size of

$$\frac{H}{2} \times \frac{W}{2} \times 2 .$$

The tensor representation of the reconstructed UV components of the image is combined with the tensor representation of the reconstructed Y component of the image in order to obtain a reconstructed image in YUV space.

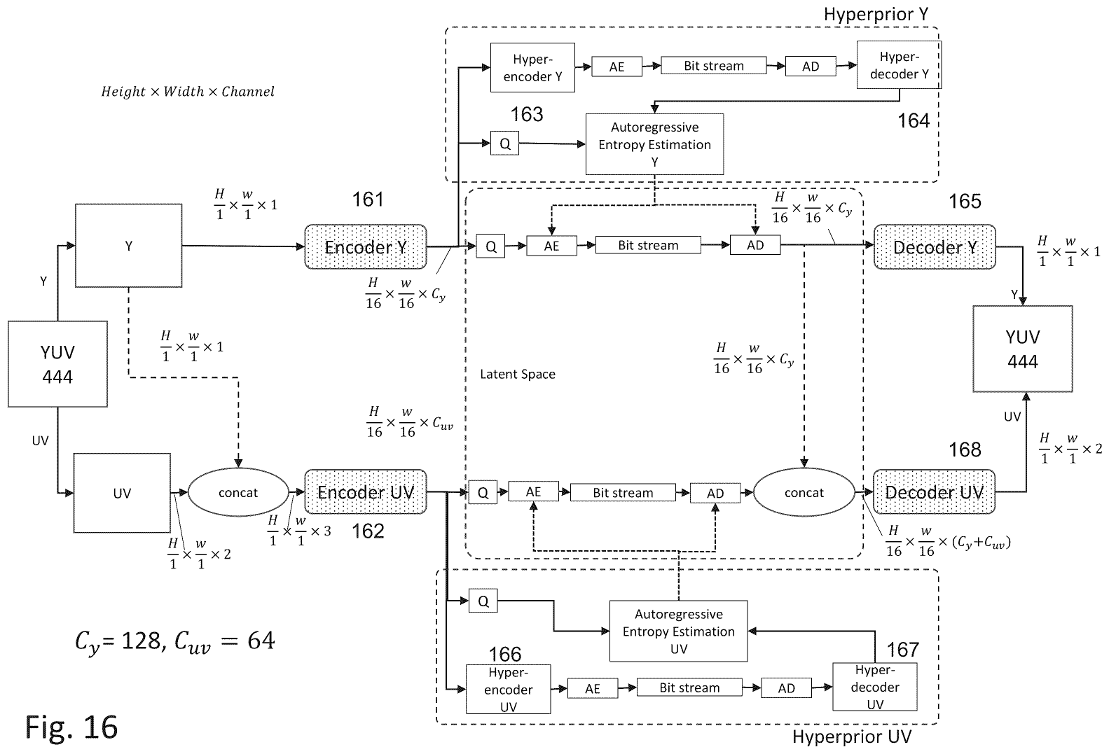

FIG. 16 illustrates an embodiment similar to the one shown in FIG. 15 but for processing of input data in the YUV444 format wherein the sizes of the tensors representing the Y and UV components, respectively, in the height widths dimensions are the same. An encoder 161 transforms the tensor

$$\frac{H}{1} \times \frac{W}{1} \times 1$$

representing the Y component of the image that is to be processed into latent space. The auxiliary information has not to be resampled according to this embodiment and, therefore, the tensor

$$\frac{H}{1} \times \frac{W}{1} \times 2$$

representing the UV components of the image that is to be processed can be directly concatenated with the tensor

$$\frac{H}{1} \times \frac{W}{1} \times 1$$

representing the Y component and the concatenated tensor

$$\frac{H}{1} \times \frac{w}{1} \times 3$$

is transformed into latent space by an encoder 162 on the UV side. Hyperprior Y pipeline comprising a (hyper) encoder 163 and a (hyper) decoder 164 and Hyperprior UV pipeline comprising a (hyper) encoder 166 and a (hyper) decoder 167 operate similar to the ones described-above with reference to FIG. 15. Since the recovered latent representations of the U component and the UV components have the same sizes in height and width they can be concatenated with each other in latent space without resampling. The recovered latent representation of the U component

$$\frac{H}{16} \times \frac{w}{16} \times {C}_{y}$$

is up-sampled by a decoder 165 and the recovered concatenated latent representation of the Y and UV components

$$\frac{H}{16} \times \frac{w}{16} \times ( {C}_{y} + {C}_{uv} )$$

is up-sampled by a decoder 168 and the outputs of the decoders 165 and 168 are combined to obtain a recovered image in YUV space.

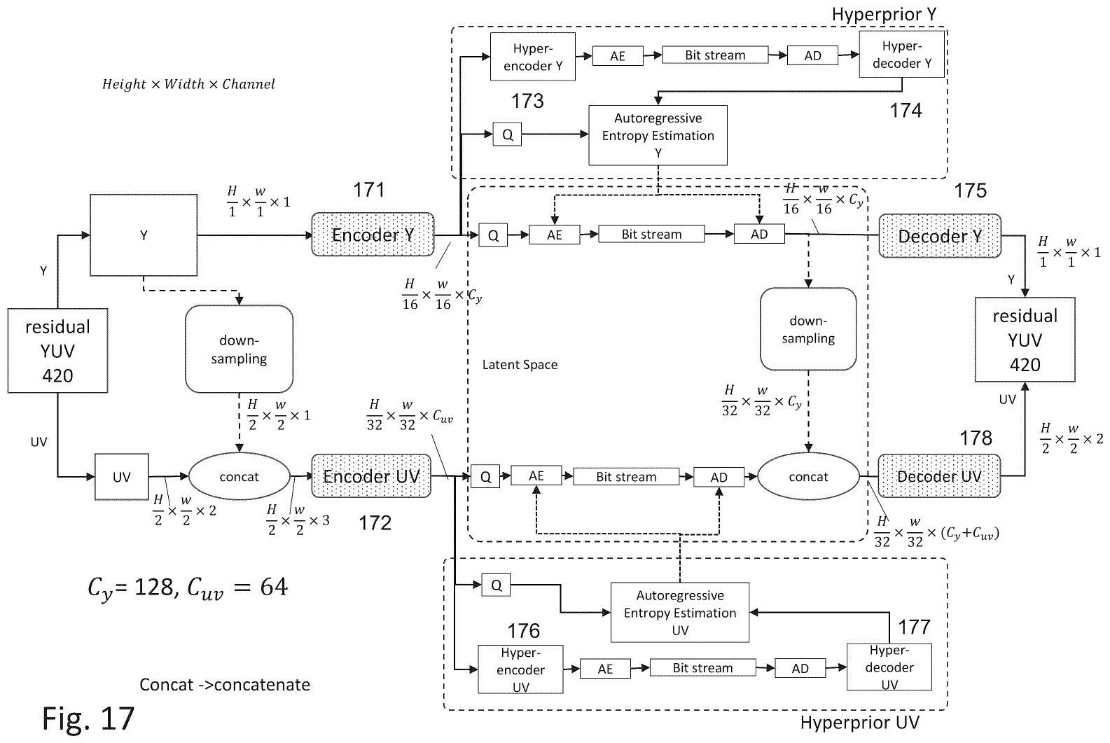

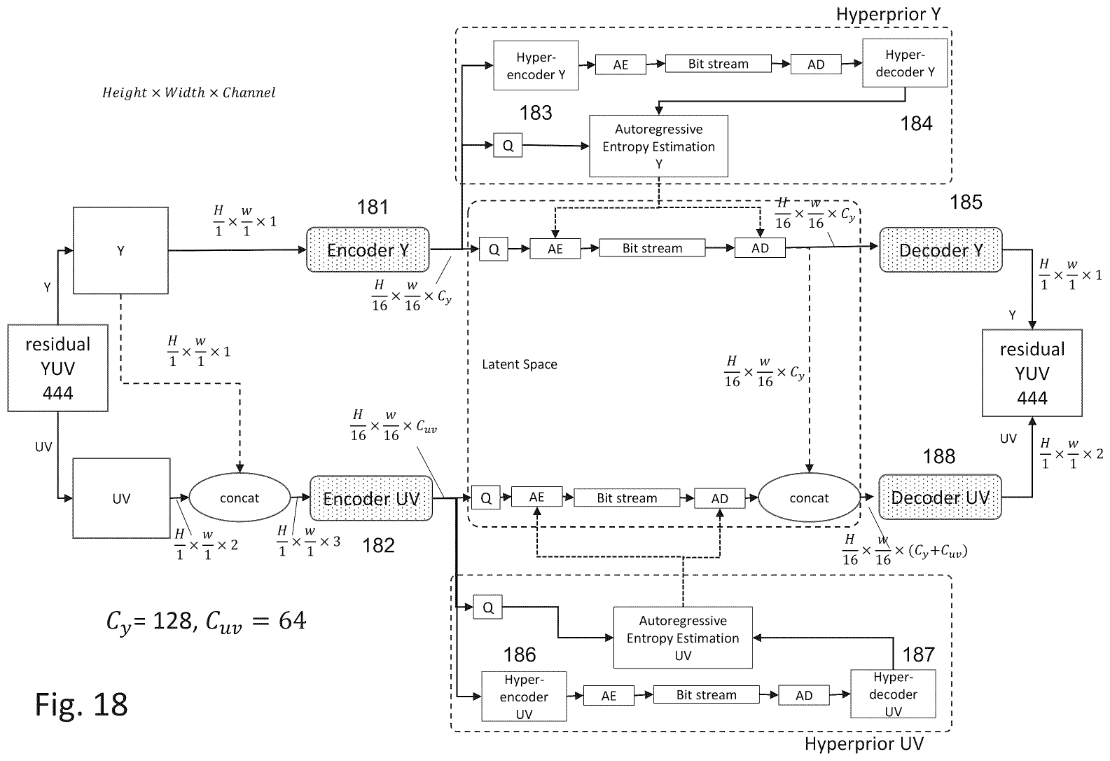

FIGS. 17 and 18 show embodiments wherein conditional residual coding is provided. The residual conditional coding may be used for inter prediction of a current frame of a video sequence or still image coding. Different from the embodiments shown in FIGS. 15 and 16 a residual comprising residual components in YUV space is processed. The residual is separated into a residual Y component for the Y component and residual UV components for the UV components. The processing of the residual components is similar to the processing of the Y and UV components as described-above with reference to FIGS. 15 and 16. According to the embodiment shown in FIG. 17, the input data is in the YUV 420 format. Thus, the residual Y component has to be down-sampled before concatenation with the residual UV components. Encoders 171 and 172 provide for the respective latent representation. Hyperprior Y pipeline comprising a (hyper) encoder 173 and a (hyper) decoder 174 and Hyperprior UV pipeline comprising a (hyper) encoder 176 and a (hyper) decoder 177 operate similar to the ones described-above with reference to FIG. 15. On the residual Y component side, a decoder 175 outputs a recovered representation of the residual Y component. On the residual UV side, a decoder 178 outputs a recovered representation of the residual UV components based on auxiliary information provided in latent space wherein down-sampling of a recovered latent representation of the residual Y component is needed. The outputs of the decoders 175 and 178 are combined to obtain a recovered residual in YUV space that can be used to obtain a recovered (portion of an) image.

According to the embodiment shown in FIG. 18, the input data is in the YUV 444 format. No down-sampling of the auxiliary information is needed. The processing of the residual Y and UV components is similar to the processing of the Y and UV components as described-above with reference to FIG. 16. An encoder 181 transforms the tensor

$$\frac{H}{1} \times \frac{W}{1} \times 1$$

representing the residual Y component of the image that is to be processed into latent space. The tensor

$$\frac{H}{1} \times \frac{W}{1} \times 2$$

representing the residual UV components of the image that is to be processed can be directly concatenated with the tensor

$$\frac{H}{1} \times \frac{W}{1} \times 1$$

representing the residual Y component and the concatenated tensor

$$\frac{H}{1} \times \frac{w}{1} \times 3$$

is transformed into latent space by an encoder 182 on the residual UV side.

Hyperprior Y pipeline comprising a (hyper) encoder 183 and a (hyper) decoder 184 and Hyperprior UV pipeline comprising a (hyper) encoder 186 and a (hyper) decoder 187 operate similar to the ones described-above with reference to FIG. 15.

Since the recovered latent representations of the residual U component and the residual UV components have the same sizes in height and width they can be concatenated with each other without resampling. The recovered latent representation of the residual U component

$$\frac{H}{16} \times \frac{w}{16} \times {C}_{y}$$

is up-sampled by a decoder 185 and the recovered concatenated latent representations of the residual Y and residual UV components

$$\frac{H}{16} \times \frac{w}{16} \times ( {C}_{y} + {C}_{u v} )$$

is up-sampled by a decoder 188 and the outputs of the decoders 185 and 188 are combined to obtain a recovered residual of an image in YUV space that can be used to obtain a recovered (portion of an) image.

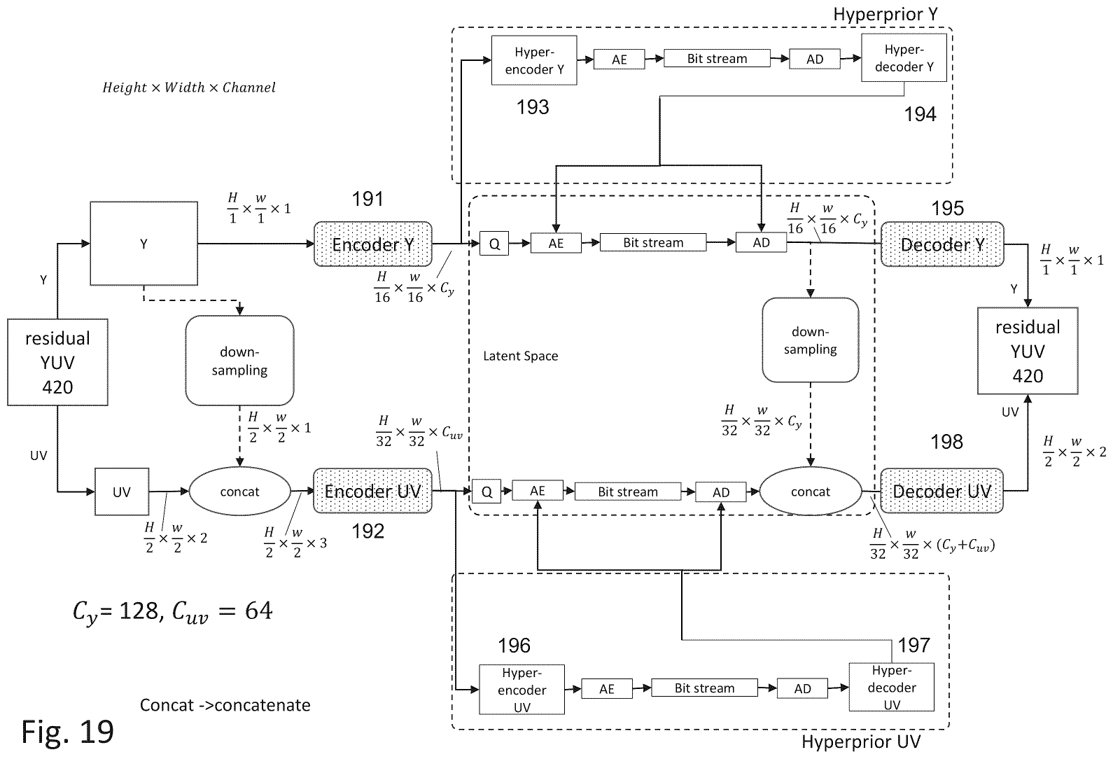

FIG. 19 shows an alternative embodiment with respect to the embodiment shown in FIG. 17. The only difference is that in the configuration shown in FIG. 19 no autoregressive entropy model is employed. A representation of a residual Y component represented by a tensor

$$\frac{H}{1} \times \frac{w}{1} \times 1$$

is transformed in latent space by an encoder 191. The residual Y component is used as auxiliary information for coding residual UV components represented by a tensor

$$\frac{H}{2} \times \frac{w}{2} \times 2$$

by means of an encoder 192 that outputs a tensor

$$\frac{H}{2} \times \frac{w}{2} \times 3 .$$

comprising a (hyper) encoder 193 and a (hyper) decoder 194 provides side information used for the coding of the latent representation of the residual Y component

$$\frac{H}{16} \times \frac{w}{16} \times {C}_{y} .$$

A decoder 195 outputs the reconstructed residual Y component represented by a tensor

$$\frac{H}{1} \times \frac{w}{1} \times 1 .$$

A Hyperprior UV pipeline comprising a (hyper) encoder 196 and a (hyper) decoder 197 provides side information used for the coding of the latent representation of the tensor

$$\frac{H}{2} \times \frac{w}{2} \times 3$$

output by the encoder 192, i.e., the tensor

$$\frac{H}{16} \times \frac{w}{16} \times {C}_{u v} .$$

A decoder 198 receives a concatenated tensor in latent space

$$\frac{H}{16} \times \frac{w}{16} \times ( {C}_{y} + {C}_{u v} )$$

and outputs reconstructed residual UV components represented by a tensor

$$\frac{H}{2} \times \frac{w}{2} \times 2 .$$

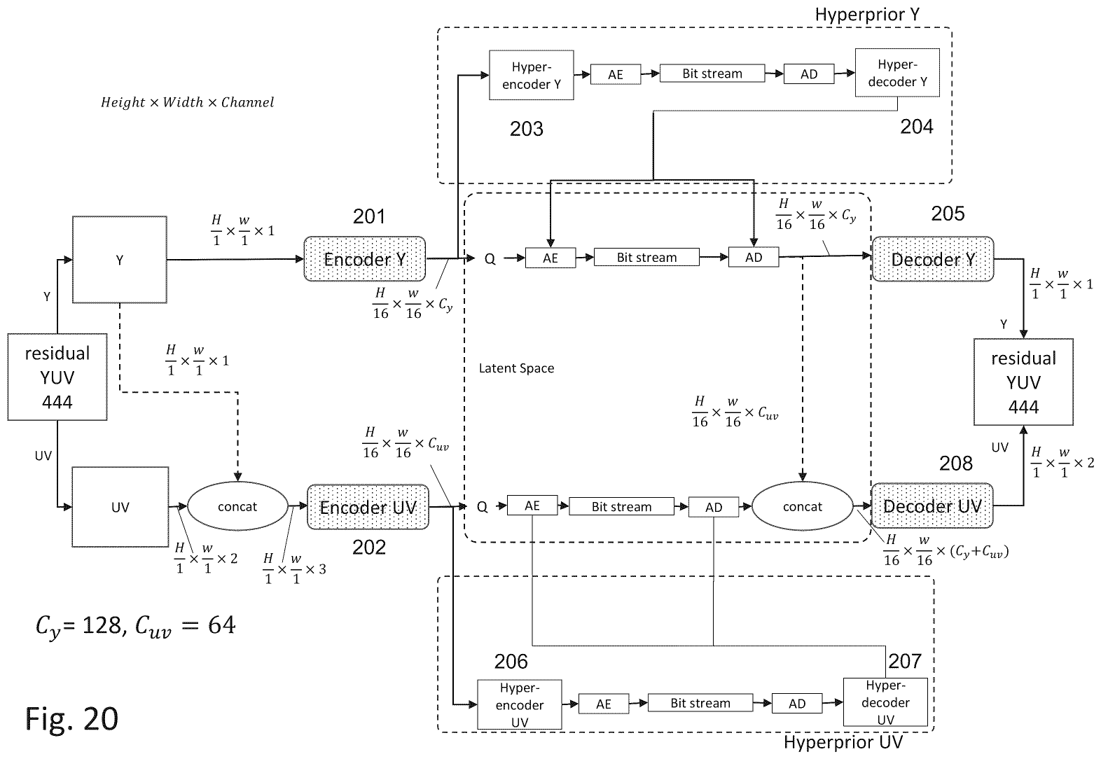

FIG. 20 shows an alternative embodiment with respect to the embodiment shown in FIG. 18. Again, the only difference is that in the configuration shown in FIG. 20 no autoregressive entropy model is employed.

A representation of a residual Y component represented by a tensor

$$\frac{H}{1} \times \frac{w}{1} \times 1$$

is transformed in latent space by an encoder 201. The residual Y component is used as auxiliary information for coding residual UV components represented by a tensor

$$\frac{H}{2} \times \frac{w}{2} \times 2$$

by means of an encoder 202 that outputs a tensor

$$\frac{H}{2} \times \frac{w}{2} \times 3 .$$

A Hyperprior Y pipeline comprising a (hyper) encoder 203 and a (hyper) decoder 204 provides side information used for the coding of the latent representation of the residual Y component

$$\frac{H}{16} \times \frac{w}{16} \times {C}_{y} .$$

A decoder 205 outputs the reconstructed residual Y component represented by a tensor

$$\frac{H}{1} \times \frac{w}{1} \times 1 .$$

A Hyperprior UV pipeline comprising a (hyper) encoder 206 and a (hyper) decoder 207 provides side information used for the coding of the latent representation of the tensor

$$\frac{H}{2} \times \frac{w}{2} \times 3$$

output by the encoder 202, i.e., the tensor

$$\frac{H}{16} \times \frac{w}{16} \times {C}_{u v} .$$

A decoder 207 receives a reconstructed representation of the residual UV components in latent space

$$\frac{H}{16} \times \frac{w}{16} \times {C}_{u v}$$

and outputs reconstructed residual UV components represented by a tensor

$$\frac{H}{2} \times \frac{w}{2} \times 2 .$$

Processing without employment of the autoregressive entropy model may reduce complexity of the overall processing and, depending on actual applications, may still provide for sufficient accuracy of the recovered images.

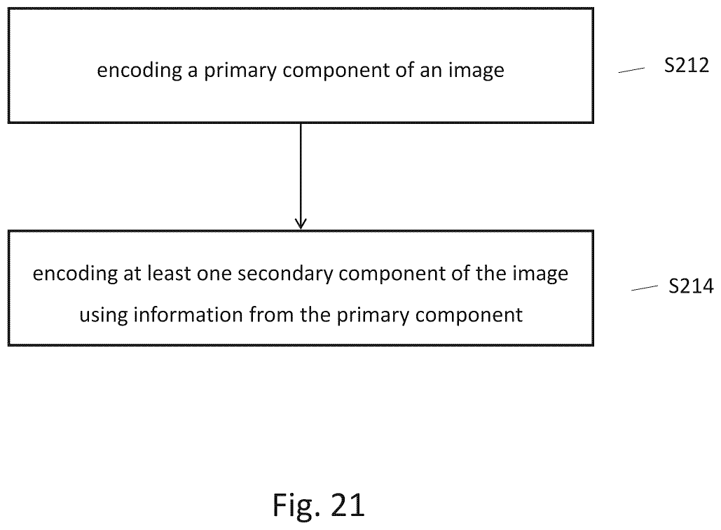

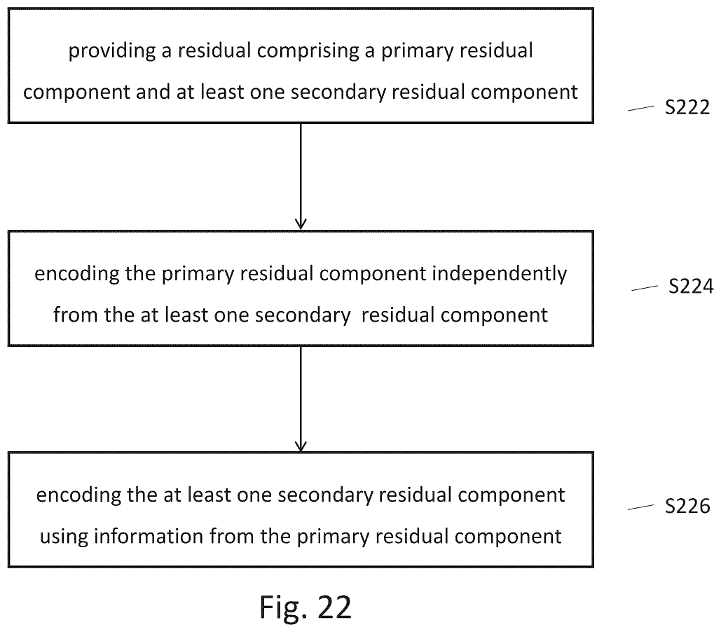

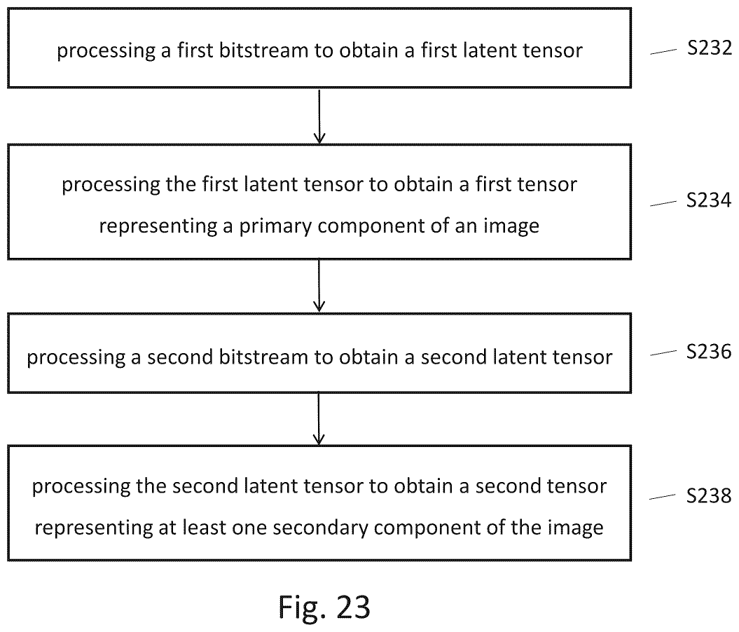

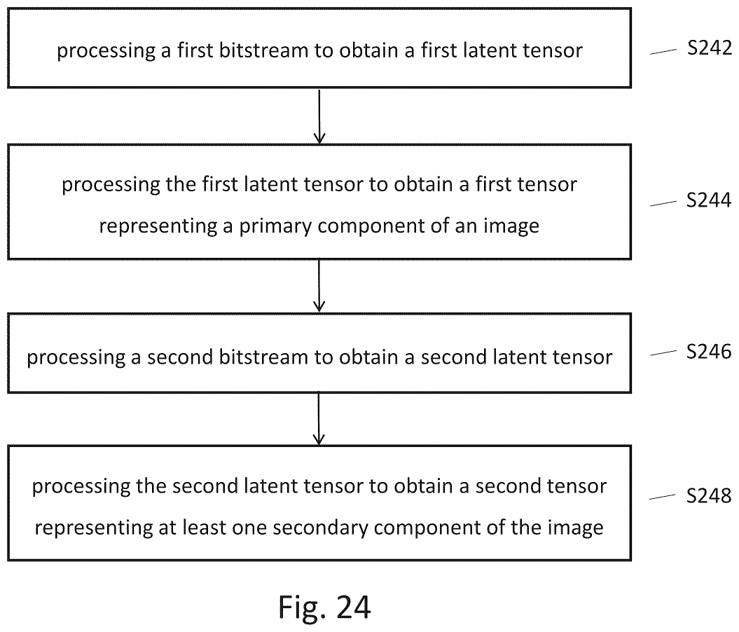

Particular embodiments of a method of encoding at least a portion of an image are illustrated in FIGS. 21 and 22 and particular embodiments of a method of reconstructing at least a portion of an image are illustrated in FIGS. 23 and 24.

The method of encoding at least a portion of an image illustrated in FIG. 21 comprises the steps of encoding S212 a primary component of the image independently from at least one secondary (non-primary) component of the image and encoding S214 the at least one secondary component of the image using information from the primary component. The primary component provides auxiliary information for the process of encoding the secondary component. Here, and in the embodiments illustrated in FIGS. 22 to 24. the image comprises a brightness component and color components and one of these components is selected to be the primary component and at least one of the other components is selected to be the at least one secondary component. For example, in YUV space, the Y component is selected as the primary component and one or both of the chroma components U and V is selected as the secondary component. Alternatively, one of the chroma components U and V is selected as the primary component and the luma component Y is selected as the secondary component.

The method of encoding at least a portion of an image illustrated in FIG. 22 comprises providing S222 a residual comprising a primary residual component for a primary component of the image and at least one secondary residual component for at least one secondary component of the image that is different from the primary component. The primary residual component is encoded S224 independently from the at least one secondary residual component and the at least one secondary residual component is encoded S226 using information from the primary residual component.

According to the embodiment illustrated in FIG. 23 a method of reconstructing at least a portion of an image comprises processing S232 a first bitstream based on a first entropy model to obtain a first latent tensor and processing S234 the first latent tensor to obtain a first tensor representing the primary component of the image. Further, a second bitstream different from the first bitstream is processed S236 based on a second entropy model different from the first entropy model to obtain a second latent tensor different from the first latent tensor and the second latent tensor is processed S238 to obtain a second tensor representing the at least one secondary component of the image using information from the first latent tensor.

According to the embodiment illustrated in FIG. 24 a method of reconstructing at least a portion of an image comprises processing S242 a first bitstream based on a first entropy model to obtain a first latent tensor and processing S244 the first latent tensor to obtain a first tensor representing a primary residual component of a residual for a primary component of the image. Further, a second bitstream different from the first bitstream is processed S246 based on a second entropy model different from the first entropy model to obtain a second latent tensor different from the first latent tensor and the second latent tensor is processed S248 to obtain a second tensor representing at least one secondary residual component of the residual for at least one secondary component of the image using information from the first latent tensor.

The methods illustrated in FIGS. 21 to 24 may be applied in the context of intra prediction, inter prediction and/or still image coding where appropriate. Furthermore, the methods illustrated in FIGS. 21 to 24 may make use of the processing (units) described with reference to FIGS. 12 to 20 in particular implementations.

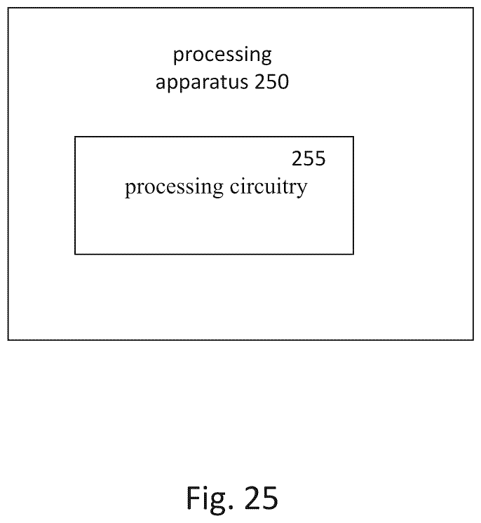

Particularly, the methods illustrated in FIGS. 21 to 24 may be implemented in a processing apparatus 250) comprising a processing circuitry 255 that is configured for performing the steps of these methods as shown in FIG. 25.

Thus, the processing apparatus 250) may be a processing apparatus 250 for encoding at least a portion of an image, the processing apparatus 250) comprising a processing circuitry 255 configured for encoding (for at least the portion of the image) a primary component of the image independently from at least one secondary component of the image and encoding (for at least the portion of the image) the at least one secondary component of the image using information from the primary component.

Alternatively, the processing apparatus 250 may be a processing apparatus 250 for encoding at least a portion of an image, the processing apparatus 250) comprising a processing circuitry 255 configured for: providing a residual comprising a primary residual component for a primary component of the image and at least one secondary residual component for at least one secondary component of the image that is different from the primary component, encoding the primary residual component independently from the at least one secondary residual component, and encoding the at least one secondary residual component using information from the primary residual component.

Alternatively, the processing apparatus 250 may be a processing apparatus 250 for reconstructing at least a portion of an image, the processing apparatus 250) comprising a processing circuitry 255 configured for: processing a first bitstream based on a first entropy model to obtain a first latent tensor, processing the first latent tensor to obtain a first tensor representing the primary component of the image, processing a second bitstream different from the first bitstream based on a second entropy model different from the first entropy model to obtain a second latent tensor different from the first latent tensor, and processing the second latent tensor to obtain a second tensor representing the at least one secondary component of the image using information from the first latent tensor.

Alternatively, the processing apparatus 250 may be a processing apparatus 250 for reconstructing at least a portion of an image, the processing apparatus 250 comprising a processing circuitry 255 configured for: processing a first bitstream based on a first entropy model to obtain a first latent tensor, processing the first latent tensor to obtain a first tensor representing a primary residual component of a residual for a primary component of the image, processing a second bitstream different from the first bitstream based on a second entropy model different from the first entropy model to obtain a second latent tensor different from the first latent tensor, and processing the second latent tensor to obtain a second tensor representing at least one secondary residual component of the residual for at least one secondary component of the image using information from the first latent tensor.

### Some Exemplary Implementations in Hardware and Software

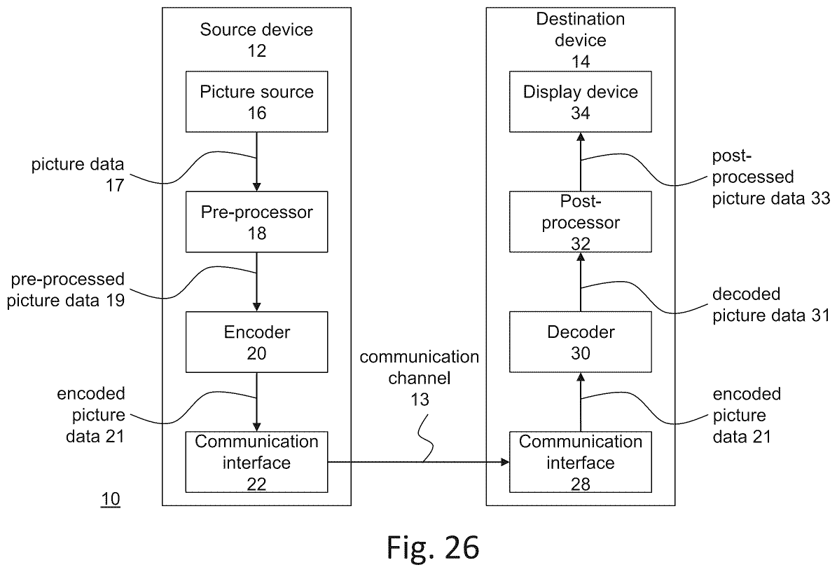

The corresponding systems which may deploy the above-mentioned encoder-decoder processing chain is illustrated in FIG. 26. FIG. 26 is a schematic block diagram illustrating an example coding system, e.g. a video, image, audio, and/or other coding system (or short coding system) that may utilize techniques of this present application. Video encoder 20 (or short encoder 20) and video decoder 30 (or short decoder 30) of video coding system 10 represent examples of devices that may be configured to perform techniques in accordance with various examples described in the present application. For example, the video coding and decoding may employ neural network such as the one shown in FIGS. 1 to 6 which may be distributed and which may apply the above-mentioned bitstream parsing and/or bitstream generation to convey feature maps between the distributed computation nodes (two or more).

As shown in FIG. 26, the coding system 10 comprises a source device 12 configured to provide encoded picture data 21 e.g. to a destination device 14 for decoding the encoded picture data 13.

The source device 12 comprises an encoder 20, and may additionally, i.e. optionally, comprise a picture source 16, a pre-processor (or pre-processing unit) 18, e.g. a picture pre-processor 18, and a communication interface or communication unit 22.

The picture source 16 may comprise or be any kind of picture capturing device, for example a camera for capturing a real-world picture, and/or any kind of a picture generating device, for example a computer-graphics processor for generating a computer animated picture, or any kind of other device for obtaining and/or providing a real-world picture, a computer generated picture (e.g. a screen content, a virtual reality (VR) picture) and/or any combination thereof (e.g. an augmented reality (AR) picture). The picture source may be any kind of memory or storage storing any of the aforementioned pictures.

In distinction to the pre-processor 18 and the processing performed by the pre-processing unit 18, the picture or picture data 17 may also be referred to as raw picture or raw picture data 17.

Pre-processor 18 is configured to receive the (raw) picture data 17 and to perform pre-processing on the picture data 17 to obtain a pre-processed picture 19 or pre-processed picture data 19. Pre-processing performed by the pre-processor 18 may, e.g., comprise trimming, color format conversion (e.g. from RGB to YCbCr), color correction, or de-noising. It can be understood that the pre-processing unit 18 may be optional component. It is noted that the pre-processing may also employ a neural network (such as in any of FIGS. 1 to 7) which uses the presence indicator signaling.

The video encoder 20 is configured to receive the pre-processed picture data 19 and provide encoded picture data 21.

Communication interface 22 of the source device 12 may be configured to receive the encoded picture data 21 and to transmit the encoded picture data 21 (or any further processed version thereof) over communication channel 13 to another device, e.g. the destination device 14 or any other device, for storage or direct reconstruction.

The destination device 14 comprises a decoder 30 (e.g. a video decoder 30), and may additionally, i.e. optionally, comprise a communication interface or communication unit 28, a post-processor 32 (or post-processing unit 32) and a display device 34.

The communication interface 28 of the destination device 14 is configured receive the encoded picture data 21 (or any further processed version thereof), e.g. directly from the source device 12 or from any other source, e.g. a storage device, e.g. an encoded picture data storage device, and provide the encoded picture data 21 to the decoder 30.

The communication interface 22 and the communication interface 28 may be configured to transmit or receive the encoded picture data 21 or encoded data 13 via a direct communication link between the source device 12 and the destination device 14, e.g. a direct wired or wireless connection, or via any kind of network, e.g. a wired or wireless network or any combination thereof, or any kind of private and public network, or any kind of combination thereof.

The communication interface 22 may be, e.g., configured to package the encoded picture data 21 into an appropriate format, e.g. packets, and/or process the encoded picture data using any kind of transmission encoding or processing for transmission over a communication link or communication network.

The communication interface 28, forming the counterpart of the communication interface 22, may be, e.g., configured to receive the transmitted data and process the transmission data using any kind of corresponding transmission decoding or processing and/or de-packaging to obtain the encoded picture data 21.

Both. communication interface 22 and communication interface 28 may be configured as unidirectional communication interfaces as indicated by the arrow for the communication channel 13 in FIG. 26 pointing from the source device 12 to the destination device 14, or bi-directional communication interfaces, and may be configured, e.g. to send and receive messages, e.g. to set up a connection, to acknowledge and exchange any other information related to the communication link and/or data transmission, e.g. encoded picture data transmission. The decoder 30 is configured to receive the encoded picture data 21 and provide decoded picture data 31 or a decoded picture 31 (e.g., employing a neural network based on one or more of FIGS. 1 to 7).

The post-processor 32 of destination device 14 is configured to post-process the decoded picture data 31 (also called reconstructed picture data), e.g. the decoded picture 31, to obtain post-processed picture data 33, e.g. a post-processed picture 33. The post-processing performed by the post-processing unit 32 may comprise, e.g. color format conversion (e.g. from YCbCr to RGB), color correction, trimming, or re-sampling, or any other processing, e.g. for preparing the decoded picture data 31 for display, e.g. by display device 34.

The display device 34 of the destination device 14 is configured to receive the post-processed picture data 33 for displaying the picture, e.g. to a user or viewer. The display device 34 may be or comprise any kind of display for representing the reconstructed picture, e.g. an integrated or external display or monitor. The displays may, e.g. comprise liquid crystal displays (LCD), organic light emitting diodes (OLED) displays, plasma displays, projectors, micro LED displays, liquid crystal on silicon (LCoS), digital light processor (DLP) or any kind of other display.

Although FIG. 26 depicts the source device 12 and the destination device 14 as separate devices, embodiments of devices may also comprise both or both functionalities, the source device 12 or corresponding functionality and the destination device 14 or corresponding functionality. In such embodiments the source device 12 or corresponding functionality and the destination device 14 or corresponding functionality may be implemented using the same hardware and/or software or by separate hardware and/or software or any combination thereof.

As will be apparent for the skilled person based on the description, the existence and (exact) split of functionalities of the different units or functionalities within the source device 12 and/or destination device 14 as shown in FIG. 26 may vary depending on the actual device and application.

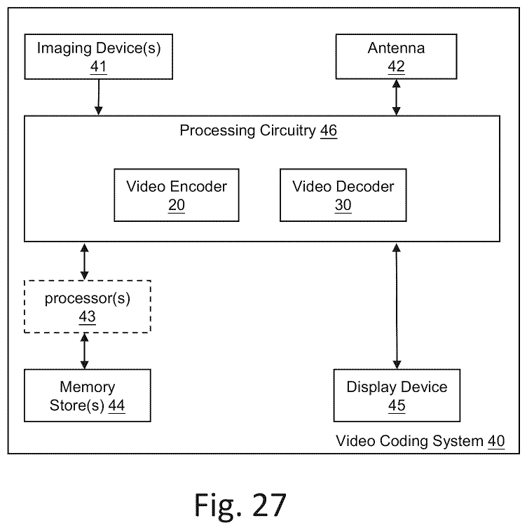

The encoder 20 (e.g. a video encoder 20) or the decoder 30 (e.g. a video decoder 30) or both encoder 20 and decoder 30 may be implemented via processing circuitry, such as one or more microprocessors, digital signal processors (DSPs), application-specific integrated circuits (ASICs), field-programmable gate arrays (FPGAs), discrete logic, hardware, video coding dedicated or any combinations thereof. The encoder 20 may be implemented via processing circuitry 46 to embody the various modules including the neural network such as the one shown in any of FIGS. 1 to 6 or its parts. The decoder 30 may be implemented via processing circuitry 46 to embody the various modules as discussed with respect to FIGS. 1 to 7 and/or any other decoder system or subsystem described herein. The processing circuitry may be configured to perform the various operations as discussed later. If the techniques are implemented partially in software, a device may store instructions for the software in a suitable, non-transitory computer-readable storage medium and may execute the instructions in hardware using one or more processors to perform the techniques of this disclosure. Either of video encoder 20 and video decoder 30 may be integrated as part of a combined encoder/decoder (CODEC) in a single device, for example, as shown in FIG. 27.

Source device 12 and destination device 14 may comprise any of a wide range of devices, including any kind of handheld or stationary devices, e.g. notebook or laptop computers, mobile phones, smart phones, tablets or tablet computers, cameras, desktop computers, set-top boxes, televisions, display devices, digital media players, video gaming consoles, video streaming devices(such as content services servers or content delivery servers), broadcast receiver device, broadcast transmitter device, or the like and may use no or any kind of operating system. In some cases, the source device 12 and the destination device 14 may be equipped for wireless communication. Thus, the source device 12 and the destination device 14 may be wireless communication devices.

In some cases, video coding system 10 illustrated in FIG. 26 is merely an example and the techniques of the present application may apply to video coding settings (e.g., video encoding or video decoding) that do not necessarily include any data communication between the encoding and decoding devices. In other examples, data is retrieved from a local memory, streamed over a network, or the like. A video encoding device may encode and store data to memory, and/or a video decoding device may retrieve and decode data from memory. In some examples, the encoding and decoding is performed by devices that do not communicate with one another, but simply encode data to memory and/or retrieve and decode data from memory.

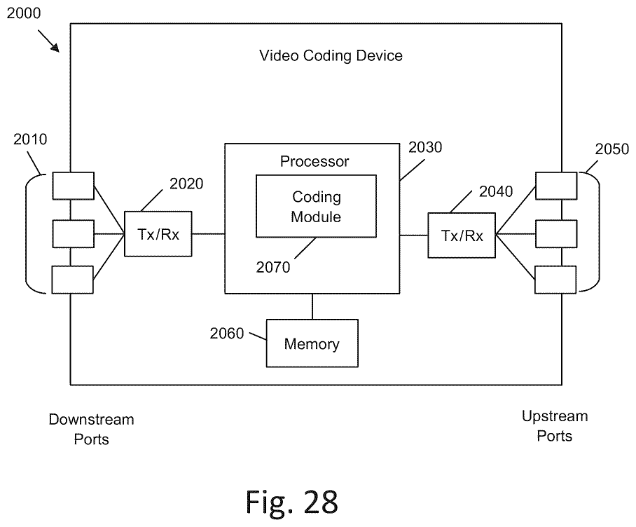

FIG. 28 is a schematic diagram of a video coding device 2000 according to an embodiment of the disclosure. The video coding device 2000 is suitable for implementing the disclosed embodiments as described herein. In an embodiment, the video coding device 2000 may be a decoder such as video decoder 30 of FIG. 26 or an encoder such as video encoder 20 of FIG. 26.

The video coding device 2000 comprises ingress ports 2010 (or input ports 2010) and receiver units (Rx) 2020 for receiving data; a processor, logic unit, or central processing unit (CPU) 2030 to process the data; transmitter units (Tx) 2040 and egress ports 2050 (or output ports 2050) for transmitting the data; and a memory 2060 for storing the data. The video coding device 2000 may also comprise optical-to-electrical (OE) components and electrical-to-optical (EO) components coupled to the ingress ports 2010, the receiver units 2020, the transmitter units 2040, and the egress ports 2050 for egress or ingress of optical or electrical signals.

The processor 2030 is implemented by hardware and software. The processor 2030 may be implemented as one or more CPU chips, cores (e.g., as a multi-core processor), FPGAs, ASICs, and DSPs. The processor 2030 is in communication with the ingress ports 2010, receiver units 2020, transmitter units 2040, egress ports 2050, and memory 2060. The processor 2030 comprises a coding module 2070. The coding module 2070 implements the disclosed embodiments described above. For instance, the coding module 2070 implements, processes, prepares, or provides the various coding operations. The inclusion of the coding module 2070 therefore provides a substantial improvement to the functionality of the video coding device 2000 and effects a transformation of the video coding device 2000 to a different state. Alternatively, the coding module 2070 is implemented as instructions stored in the memory 2060 and executed by the processor 2030.

The memory 2060 may comprise one or more disks, tape drives, and solid-state drives and may be used as an over-flow data storage device, to store programs when such programs are selected for execution, and to store instructions and data that are read during program execution. The memory 2060 may be, for example, volatile and/or non-volatile and may be a read-only memory (ROM), random access memory (RAM), ternary content-addressable memory (TCAM), and/or static random-access memory (SRAM).

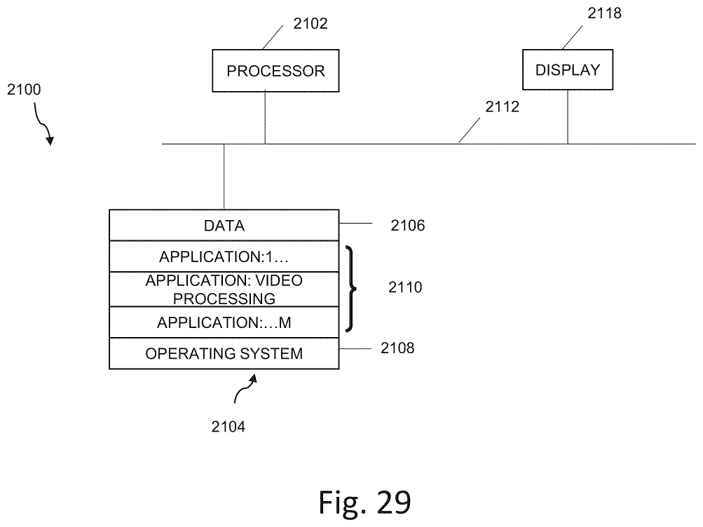

FIG. 29 is a simplified block diagram of an apparatus 800 that may be used as either or both of the source device 12 and the destination device 14 from FIG. 26 according to an exemplary embodiment.

A processor 2102 in the apparatus 2100 can be a central processing unit. Alternatively, the processor 2102 can be any other type of device, or multiple devices, capable of manipulating or processing information now-existing or hereafter developed. Although the disclosed implementations can be practiced with a single processor as shown, e.g., the processor 2102, advantages in speed and efficiency can be achieved using more than one processor.

A memory 2104 in the apparatus 2100 can be a read only memory (ROM) device or a random access memory (RAM) device in an implementation. Any other suitable type of storage device can be used as the memory 2104. The memory 2104 can include code and data 2106 that is accessed by the processor 2102 using a bus 2112. The memory 2104 can further include an operating system 2108 and application programs 2110, the application programs 2110 including at least one program that permits the processor 2102 to perform the methods described here. For example, the application programs 2110 can include applications 1 through N, which further include a video coding application that performs the methods described here.

The apparatus 2100 can also include one or more output devices, such as a display 2118. The display 2118 may be, in one example, a touch sensitive display that combines a display with a touch sensitive element that is operable to sense touch inputs. The display 2118 can be coupled to the processor 2102 via the bus 2112.

Although depicted here as a single bus, the bus 2112 of the apparatus 2100 can be composed of multiple buses. Further, a secondary storage can be directly coupled to the other components of the apparatus 2100 or can be accessed via a network and can comprise a single integrated unit such as a memory card or multiple units such as multiple memory cards. The apparatus 2100 can thus be implemented in a wide variety of configurations.

Furthermore, the processing apparatus 250 shown in FIG. 25 may comprise the source device 12 or destination device 14 shown FIG. 26, the video coding system 40 shown in FIG. 27, the video coding device 2000 shown in FIG. 28 or the apparatus 2100 shown in FIG. 29.

What is claimed is:

1. A method of encoding at least a portion of an image, the method applied to an electronic encoding device and comprising
encoding a primary component of the image independently from at least one secondary component of the image; and
encoding the at least one secondary component of the image using information from the primary component.

2. The method according to claim 1, wherein the primary component and the at least one secondary component are encoded concurrently.

3. The method according to claim 1, wherein the primary component of the image is a luma component and the at least one secondary component of the image is a chroma component.

4. The method according to claim 1, wherein the primary component of the image is a chroma component and the at least one secondary component of the image is a luma component.

5. The method according to claim 1, wherein the encoding the primary component further comprises:
representing the primary component by a first tensor;
transforming the first tensor into a first latent tensor; and
processing the first latent tensor to generate a first bitstream; and
wherein the encoding the at least one secondary component further comprises:
representing the at least one secondary component by a second tensor different from the first tensor;
concatenating the second tensor and the first tensor to obtain a concatenated tensor;
transforming the concatenated tensor into a second latent tensor; and
processing the second latent tensor to generate a second bitstream.

6. The method according to claim 1, wherein the encoding the primary component further comprises:
representing the primary component by a first tensor having a height dimension and a width dimension;
transforming the first tensor into a first latent tensor; and
processing the first latent tensor to generate a first bitstream; and
wherein the encoding the at least one secondary component further comprises:
representing the at least one secondary component by a second tensor different from the first tensor and having a height dimension and a width dimension;
determining whether the size or a sub-pixel offset of samples of the second tensor in at least one of the height and width dimensions differs from the size or sub-pixel offset of samples in at least one of the height and width dimensions of the first tensor, and based on a determination that the size or sub-pixel offset of samples of the second tensor differs from the size or sub-pixel offset of samples of the first tensor, adjusting the sample locations of the first tensor to match the sample locations of the second tensor to obtain an adjusted first tensor;
concatenating the second tensor and the adjusted first tensor to obtain a concatenated tensor only based on a determination that the size or sub-pixel offset of samples of the second tensor differs from the size or sub-pixel offset of samples of the first tensor and else concatenating the second tensor and the first tensor to obtain a concatenated tensor;
transforming the concatenated tensor into a second latent tensor; and
processing the second latent tensor to generate a second bitstream.

7. The method according to claim 6, wherein the first latent tensor comprises a channel dimension and the second latent tensor comprises a channel dimension and wherein the size of the first latent tensor in the channel dimension is larger than, smaller than or equal to the size of the second latent tensor in the channel dimension, or
wherein the first tensor is transformed into the first latent tensor through a first neural network, and the concatenated tensor is transformed into the second latent tensor through a second neural network different from the first neural network, or
wherein the first bitstream is generated based on a first entropy model, and the second bitstream is generated based on a second entropy model different from the first entropy model.

8. A method of encoding at least a portion of an image, the method applied to an electronic encoding device and comprising:
providing a residual comprising a primary residual component for a primary component of the image and at least one secondary residual component for at least one secondary component of the image that is different from the primary component;
encoding the primary residual component independently from the at least one secondary residual component; and
encoding the at least one secondary residual component using information from the primary residual component.

9. A method of reconstructing at least a portion of an image, comprising processing a first bitstream based on a first entropy model to obtain a first latent tensor;
processing the first latent tensor to obtain a first tensor representing a primary component of the image;
processing a second bitstream different from the first bitstream based on a second entropy model different from the first entropy model to obtain a second latent tensor different from the first latent tensor; and
processing the second latent tensor to obtain a second tensor representing at least one secondary component of the image using information from the first latent tensor.

10. The method according to claim 9, wherein the first latent tensor is processed independently from the processing of the second latent tensor.

11. The method according to claim 9, wherein the primary component of the image is a luma component and the at least one secondary component of the image is a chroma component.

12. The method according to claim 9, wherein the primary component of the image is a chroma component and the at least one secondary component of the image is a luma component.

13. The method according to claim 11, wherein the second tensor represents two secondary components one of which being a chroma component and the other one being another chroma component.

14. The method according to claim 9, wherein the processing of the first latent tensor comprises transforming the first latent tensor into the first tensor; and
the processing of the second latent tensor comprises concatenating the second latent tensor and the first latent tensor to obtain a concatenated tensor and transforming the concatenated tensor into the second tensor.

15. The method according to claim 9, wherein each of the first and second latent tensors has a height and a width dimension and
the processing of the first latent tensor comprises transforming the first latent tensor into the first tensor; and
the processing of the second latent tensor comprises determining whether the size or a sub-pixel offset of samples of the second latent tensor in at least one of the height and width dimensions differs from the size or sub-pixel offset of samples in at least one of the height and width dimensions of the first latent tensor, and when it is determined that the size or sub-pixel offset of samples of the second latent tensor differs from the size or sub-pixel offset of samples of the first latent tensor, adjusting the sample locations of the first latent tensor to match the sample locations of the second latent tensor thereby obtaining an adjusted first latent tensor;
concatenating the second latent tensor and the adjusted first latent tensor to obtain a concatenated latent tensor only when it is determined that the size or sub-pixel offset of samples of the second latent tensor differs from the size or sub-pixel offset of samples of the first latent tensor and else concatenating the second latent tensor and the first latent tensor to obtain a concatenated latent tensor; and
transforming the concatenated latent tensor into the second tensor.

16. The method according to claim 9, wherein the first bitstream is processed by a first neural network and the second bitstream is processed by a second neural network different from the first neural network.

17. The method according to claim 9, wherein the first latent tensor comprises a channel dimension and the second latent tensor comprises a channel dimension and wherein the size of the first latent tensor in the channel dimension is one of larger than, smaller than and equal to the size of the second latent tensor in the channel dimension.

18. A method of reconstructing at least a portion of an image, comprising
processing a first bitstream based on a first entropy model to obtain a first latent tensor;
processing the first latent tensor to obtain a first tensor representing a primary residual component of a residual for a primary component of the image;
processing a second bitstream different from the first bitstream based on a second entropy model different from the first entropy model to obtain a second latent tensor different from the first latent tensor; and
processing the second latent tensor to obtain a second tensor representing at least one secondary residual component of the residual for at least one secondary component of the image using information from the first latent tensor.

19. The method according to claim 18, wherein the first latent tensor is processed independently from the processing of the second latent tensor.

20. The method according to claim 18, wherein the primary component of the image is a luma component and the at least one secondary component of the image is a chroma component, or
wherein the primary component of the image is a chroma component and the at least one secondary component of the image is a luma component.

21. The method according to claim 18, wherein
the processing of the first latent tensor comprises transforming the first latent tensor into the first tensor; and
the processing of the second latent tensor comprises concatenating the second latent tensor and the first latent tensor to obtain a concatenated tensor and transforming the concatenated tensor into the second tensor.

22. The method according to claim 18, wherein the first bitstream is processed by a first neural network and the second bitstream is processed by a second neural network different from the first neural network.

23. A non-transitory computer-readable medium comprising a code which when executed by one or more processors performs the method according to claim 18.

24. A processing apparatus for encoding at least a portion of an image, the processing apparatus comprising a processing circuitry configured for:
encoding a primary component of the image independently from at least one secondary component of the image; and
encoding the at least one secondary component of the image using information from the primary component.

25. A processing apparatus for reconstructing at least a portion of an image, the processing apparatus comprising a processing circuitry configured for:
processing a first bitstream based on a first entropy model to obtain a first latent tensor;
processing the first latent tensor to obtain a first tensor representing the primary component of the image;
processing a second bitstream different from the first bitstream based on a second entropy model different from the first entropy model to obtain a second latent tensor different from the first latent tensor; and
processing the second latent tensor to obtain a second tensor representing the at least one secondary component of the image using information from the first latent tensor.
